(19) United States
(12) Patent Application Publication
(10) Pub. No.: US 2007/0177919 A1
(43) Pub. Date: Aug. 2, 2007

(54) IMAGE FORMING APPARATUS, DATA PROCESSING METHOD THEREOF, AND COMPUTER-READABLE RECORDING MEDIUM STORING PROGRAM OF THE METHOD

(76) Inventors: Kazuma Saitoh, Tokyo (JP); Noboru Tamura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/668,793

(22) Filed: Jan. 30, 2007

(30) Foreign Application Priority Data
Jan. 31, 2006 (JP) 2006-023045

(51) Int. Cl. B41J 5/30

(52) U.S. Cl. 400/62

(57) ABSTRACT

An image forming apparatus is disclosed. The image forming apparatus includes a data receiving section connected to a computer via a network for receiving a command from the computer, a command processing section for processing the command received by the data receiving section, a command interpreting section for interpreting the command and a data transmitting section for transmitting device information obtained by the command processing section. The command processing section requests the command interpreting section to interpret the command before completing a start-up of a device from which the command processing section obtains the device information.

### BACKGROUND OF THE INVENTION

1. Field of the Invention

The present invention generally relates to an image forming apparatus, a data processing method thereof, and a computer-readable recording medium storing a program of the method in which a command transmitted from a computer connected via a network is processed

2. Description of the Related Art

FIG. 1 is a diagram showing a printing system including an image forming apparatus. The printing system includes an image forming apparatus 12, a computer 11, and a network 13. The computer 11 is a general-purpose computer including a CPU, a storage, a memory, a driving device, a displaying device, a communicating device, and so on. The image forming apparatus 12 includes at least a printing function, and can be a multifunctional apparatus having a facsimile function, a scanner function, and so on.

In the printing system shown in FIG. if the image forming apparatus 12 prints an image; however, the computer 11 may obtain information From the image forming apparatus 12 or may operate the image forming apparatus 12. For example the computer 11 obtains the size of a paper feeding tray loaded in the image forming apparatus 12 and can set an environmental variable of the image forming apparatus 12. The above is disclosed in Patent Document 1.

In Patent Document 1, the image forming apparatus 12 transmits printing status to the computer 11 which status shows output unit price information functions of the apparatus, ability of the apparatus, and information in the apparatus. The computer 11 can obtain the printing status from plural image forming apparatuses (not shown) and can request a print job from an image forming apparatus whose output unit price is low.

[Patent Document 1 ] Japanese Laid-Open Patent Application No. 2001-229001

The image forming apparatus 12 includes a device such as an HDD (hard disk drive) for storing print data, setting information of a print jobs and so on. Generally, when a user does not operate the apparatus for a certain period, the power consumption of the device is reduced by using an energy saving mode.

FIG. 2 is a sequence chart for obtaining designated information of a device in the image forming apparatus 12. In FIG. 2, the image forming apparatus 12 includes a command interpreting section 21, a command processing section 22, and a device controlling section 23. The command processing section 22 processes a command transmitted from the computer 11, the command interpreting section 21 interprets the command, and the device controlling section 23 controls a device, for example, an HDD.

When the command processing section 22 receives a command from the computer 11 (S1) the command processing section 22 informs the device controlling section 23 of a device having information designated by the command and starts up the device when the device is in a standby mode (S2) After starting up the device, for example, an HDD, that is, after several seconds or some tens of seconds, the device controlling section 23 informs the command processing section 22 of the start-up of the HDD (S3). The command processing section 22 requests the command interpreting section 21 to interpret the command (S4).

The command interpreting section 21 interprets the command and requests the command processing section 22 to process the command based on the interpretation of the command (S5). The command processing section 22 processes the command. That is, the command processing section 22 obtains the information designated by the command from the device (HDD) via the device controlling section 23

However, in the sequence chart shown in FIG. 2, since several seconds or some tens of seconds have passed from receiving the command to requesting the interpretation of the command, a time-out problem may occur in the above seconds

### SUMMARY OF THE INVENTION

In a preferred embodiment of the present invention, there is provided an image forming apparatus, a data processing method thereof, and a computer-readable recording medium storing a program of the method, in which a time-out problem does not occur even if a device has not been started up in which device information designated by a command is stored.

Features and advantages of the present invention are set forth in the description that follows, and in part will become apparent from the description and the accompanying drawings, or may be learned by practice of the invention according to the teachings provided in the description. Features and advantages of the present invention will be realized and attained by an image forming apparatus, a data processing method thereof, and a computer-readable recording medium storing a program of the method particularly pointed out in the specification in such full, clear, concise, and exact terms as to enable a person having ordinary skill in the art to practice the invention.

To achieve one or more of these and other advantages, according to one aspect of the present invention, there is provided an image forming apparatus. The image forming apparatus includes a data receiving section connected to a computer via a network for receiving a command from the computer, a command processing section for processing the command received by the data receiving section a command interpreting section for interpreting the command, and a data transmitting section for transmitting device information obtained by the command processing section. The command processing section requests the command interpreting section to interpret the command before completing a start-up of a device from which the command processing section obtains the device information.

According to another aspect of the present invention, there is provided an image forming apparatus. The image forming apparatus includes a data receiving section connected to a computer via a network for receiving a command from the computer, a command processing section for processing the command received by the data receiving section, a command interpreting section for interpreting the command, and a data transmitting section for transmitting device information obtained by the command processing section. When a device is connected to the image forming apparatus via the network from which device the command processing section obtains the device information, the command processing section requests the command interpreting section to interpret the command before accessing the device via the network.

According to another aspect of the present invention, there is provided a data processing method in an image forming apparatus. The data processing method includes the steps of receiving a command from a computer connected via a network, requesting to start up a device from which device information is obtained based on the command, interpreting the command before completing the start-up of the device processing the command based on an interpreted result, obtaining the device information from the devices and transmitting the obtained device information to the computer.

### EFFECT OF THE INVENTION

According to an embodiment of the present invention, in an image forming apparatus, a data processing method thereof, and a computer-readable recording medium storing a program of the methods a time-out problem does not occur even if a device has not been started up in which device information designated by a command is stored.

### BRIEF DESCRIPTION OF THE DRAWINGS

Features and advantages of the present invention will become more apparent from the following detailed description when read in conjunction with the accompanying drawings, in which:

FIG. 1 is a diagram showing a printing system including an image forming apparatus;

FIG. 2 is a sequence chart for obtaining designated information of a device in the image forming apparatus;

FIG. 3 is a block diagram showing an image forming apparatus in a printing system according to a first embodiment of the present invention;

FIG. 4 is a functional diagram of the image forming apparatus connected to a computer according to the first embodiment of the present invention;

FIG. 5 is a sequence chart showing processes for executing a command in the image forming apparatus according to the first embodiment of the present invention;

FIG. 6 is a conceptual flowchart showing processes in a command processing section according to the first embodiment of the present invention;

FIG. 7 is a device table showing a relationship between a command and a device according to the first embodiment of the present invention;

FIG. 8 is a sleep mode table showing a relationship between a sleep mode and a device;

FIG. 9 is a flowchart showing processes in a command interpreting section;

FIG. 10 is a flowchart showing processes in the command processing section when a device must be started up;

FIG. 11 is a flowchart showing processes in the command processing section when the device does not need to be started up;

FIG. 12 is a flowchart showing processes in a device controlling section;

FIG. 13 is a flowchart showing processes in the command processing section in winch the device is started up after interpreting the command when the device must be started up;

FIG. 14 is a diagram showing a printing system including an image forming apparatus according to a second embodiment of the present invention;

FIG. 15 is a flowchart showing processes in the command processing section when a device connected via a network is used;

FIG. 16 is a device table showing a relationship between a command and a device according to the second embodiment of the present invention;

FIG. 17 is a diagram showing a printing system including an image forming apparatus according to a third embodiment of the present invention;

FIG. 18 is a flowchart showing processes in the command processing section when the devices connected via the network are used;

FIG. 19A is a flowchart showing processes for caching device information in a cache memory by the device controlling section;

FIG. 19B is another flowchart showing processes for caching device information in a cache memory by the device controlling section;

FIG. 20 is a flowchart showing processes in the command processing section when the device information is stored in a cache memory according to a fourth embodiment of the present invention;

FIG. 21 is a device information presence table according to the fourth embodiment of the present invention;

FIG. 22 is a flowchart showing processes in the command processing section when the device information is stored in the cache memory according to a fifth embodiment of the present invention;

FIG. 23 is an unchangeable device information obtaining command table according to the fifth embodiment of the present invention;

FIG. 24 is a flowchart showing processes in the command processing section when the device information is stored in a cache memory according to a sixth embodiment of the present invention;

FIG. 25 is a command source address table according to the sixth embodiment of the present invention;

FIG. 26 is a flowchart showing processes in the command processing section when the device information is stored in a cache memory according to a seventh embodiment of the present invention;

FIG. 27 is a command table according to the seventh embodiment of the present invention;

FIG. 28 is a flowchart showing processes in the command processing section when the device information is stored in the cache memory according to an eight embodiment of the present invention;

FIG. 29 is a command source address table according to the eighth embodiment of the present invention;

FIG. 30 is a flowchart showing processes in the command processing section when the device information is stored in a cache memory according to a ninth embodiment of the present invention;

FIG. 31 is a command table according to the ninth embodiment of the present invention;

FIG. 32 is a flowchart showing processes in the command processing section when the device information is stored in a cache memory according to a tenth embodiment of the present invention;

FIG. 33A is a command source address table according to the tenth embodiment of the present invention;

FIG. 33B is a predetermined time table according to the tenth embodiment of the present invention;

FIG. 34 is a flowchart showing processes in the command processing section when the device information is stored in a cache memory according to an eleventh embodiment of the present invention;

FIG. 35A is a command table according to the eleventh embodiment of the present invention; and

FIG. 35B is a predetermined time table according to the eleventh embodiment of the present invention.

### DESCRIPTION OF THE PREFERRED EMBODIMENTS

### Best Mode of Carrying Out the Invention

The best mode of carrying out the present invention is described with reference to the accompanying drawings.

### First Embodiment

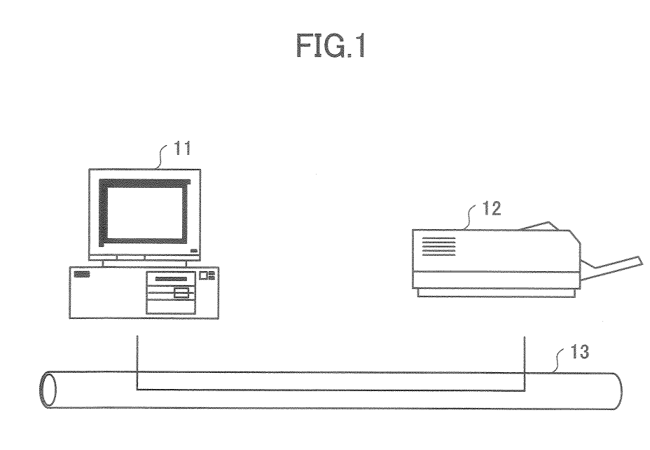

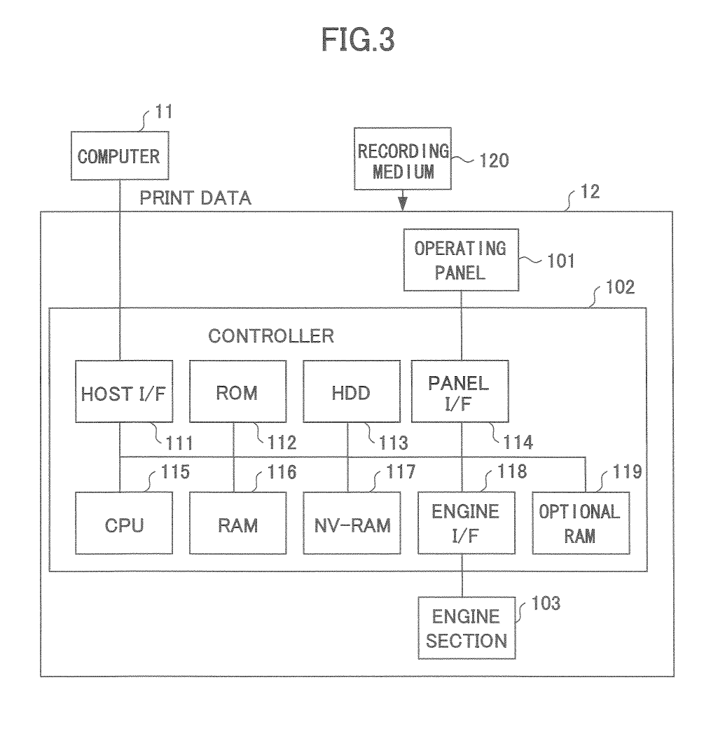

FIG. 3 is a block diagram showing an image forming apparatus in a printing system according to a first embodiment of the present invention. In FIG. 3, in addition to an image forming apparatus 12, a computer 11 and a recording medium 120 are shown. In FIG. 3, the image forming apparatus 12 includes an operating panel 101, a controller 102, and an engine section 103. The image forming apparatus 12 shown in FIG. 3 has the same reference number as that shown in FIG. 1; however, the structure of the image forming apparatus 12 shown in FIG. 3 is different from that shown in FIG. 1.

The controller 102 includes a host I/F 111, a ROM 112, an HDD 113, a panel I/F 114, a CPU 115, a RAM 116, an NV-RAM (non-volatile RAM) 117, an engine I/F 118, and an optional RAM 119.

Programs being executed by the CPU 115 have been stored in the ROM 112 When the power supply of the image forming apparatus 12 is turned on, the CPU 115 loads a program and controls the controller 102

The RAM 116 and the optional RAM 119 are work memories when programs are executed, and temporarily store print data received from the computer 11 based on an instruction from the CPU 115.

In the NV-RAM 117, proper information of the image forming apparatus 12 is stored. For example, the counted number of copied paper, the serial number of the apparatus, and the ID number of the manager of the apparatus.

The HDD 113 is a magnetic-storage device which writes and reads data by using a magnetic head while a metal disk is rotated on which disk a magnetic material is applied or disposed. The print data and files of the print data are stored in the HDD 113.

The operating panel 101 is a man-machine interface and includes buttons and a touch panel for operations, indicators such as LEDs and LCDs for displaying the status of the apparatus, a speaker, and so on. The operating panel 101 is connected to the panel I/F 114 of the controller 102. When a user operates the operating panel 101, the panel I/F 114 sends a control signal to the CPU 115 based on the operation of the user.

The host I/F 111 receives print data from the computer 11 connected via a network. The host I/F 111 is connected to the computer 11 via, for example, a NIC (network interface card) of Ethernet. In addition, the image forming apparatus 12 can be connected to the computer 11 via a LAN, a wireless network, or a wired network.

The engine section 103 is an image forming section which forms an image from the print data, and is connected to the controller 102 via the engine I/F 118 The engine I/F 118 sends the print data transmitted from the computer 11 to the engine section 103. The engine section 103 forms a toner image on a photoconductor drum by using an electrophotographic process. Then, the engine section 103 transfers the toner image onto a paper and fixes the toner image by using a fixing unit (not shown) while heat and pressure are applied to the toner image.

As the image forming system in the engine section 103, an inkjet system can be used; however, the system is not limited to the inkjet system. The engine section 103 can include a scanner engine (not shown) and a facsimile engine (not shown) in addition to the print engine.

In addition, the image forming apparatus 12 further includes a medium I/F (not shown) to which a removable medium such as a SD card and a MMC (multi media card) is connected.

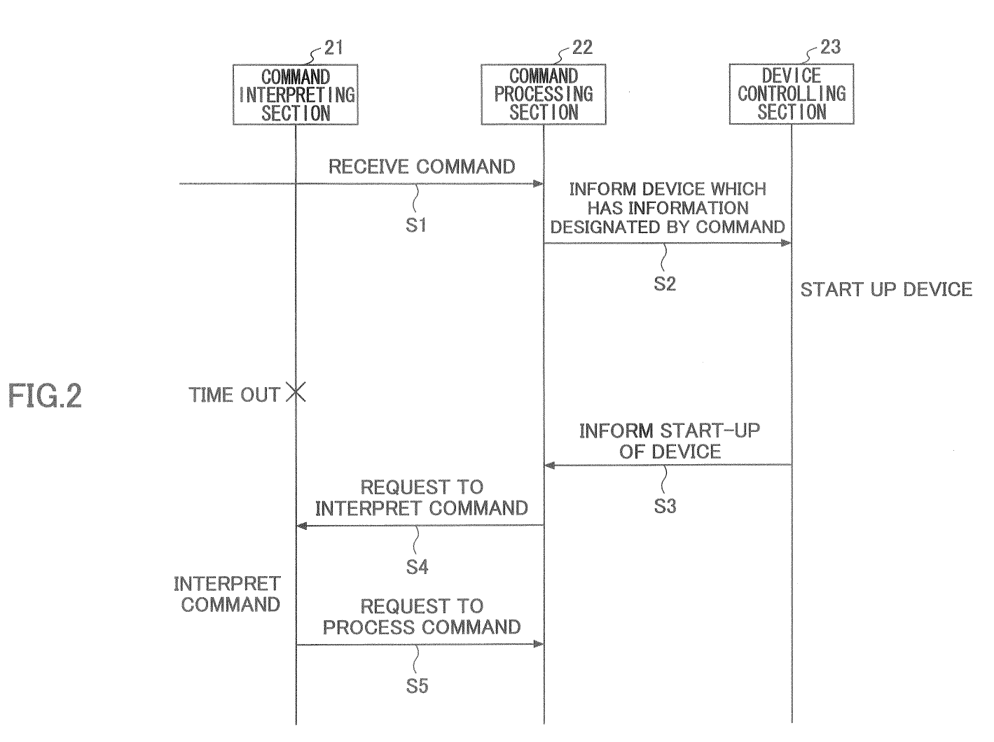

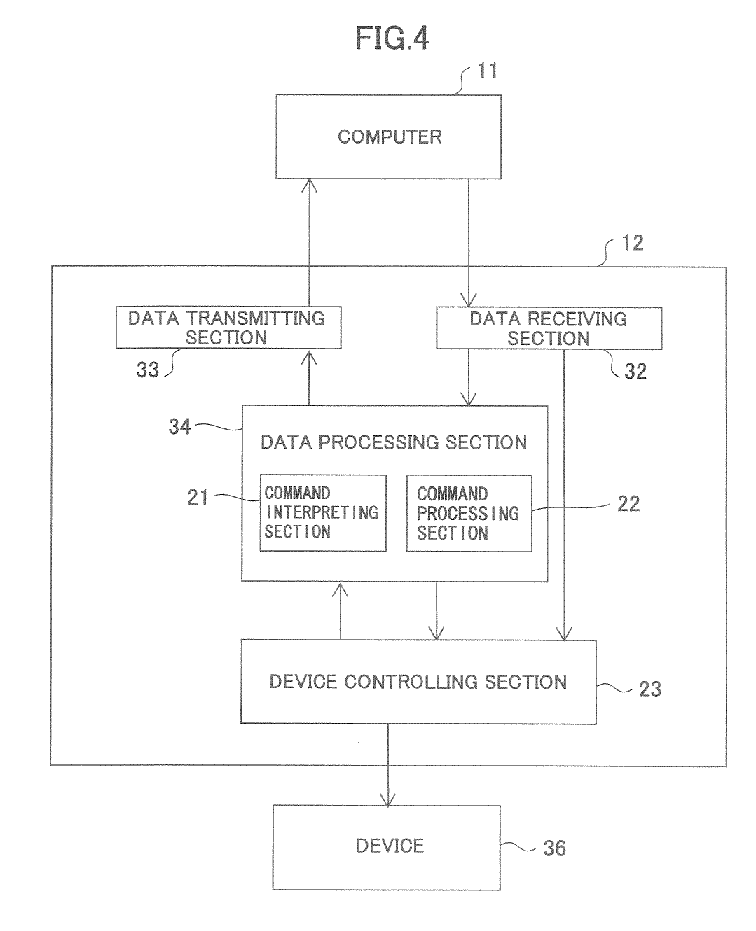

FIG. 4 is a functional diagram o the image forming apparatus 12 connected to the computer 11 according to the first embodiment of the present invention. In FIG. 4, a device 36 is shown, and the device 36 is described below. Functions in FIG. 4 are realized when the CPU 115 executes programs. As shown in FIG. 4, the image forming apparatus 12 includes a data receiving section 32, a data transmitting section 33, a data processing section 34, and a device controlling section 23. In this, the device controlling section 23 has the same reference number as that shown in FIG. 2; however, the processes therein are different from those shown in FIG. 2. The data receiving section 32 receives print data and a command transmitted from the computer 11 and sends the print data and the command to the data processing section 34 The data processing section 34 includes a command interpreting section 21 and a command processing section 22. In this, each of the command interpreting section 21 and the command processing section 22 has the same reference number as that shown in FIG. 2; however, the processes therein are different from those shown in FIG. 2

The command processing section 22 processes a command transmitted from the computer 11 In processing the command, the command processing section 22 obtains device information such as print executing information from a device in the image forming apparatus 12 or a device connected to the image forming apparatus 12 via a network That is, the device 36 can be the HDD 113 in the image forming apparatus. The device 36 is described below in detail.

The command processing section 22 receives a command sent from the data receiving section 32, extracts the command, and requests the command interpreting section 21 to interpret the command. The image forming apparatus 12 accepts the command when the command processing section 22 sends a command interpretation request to the command interpreting section 21.

The command interpreting section 21 interprets the command written in, for example, PJL (printer job language) A command table in which commands are written in PJL has been stored in the ROM 112. After interpreting the command sent from the command processing section 22, when the device 36 is needed to process the command, the command interpreting section 21 sends the type and the contents of the command to the command processing section 22 as a command processing request.

After receiving the command processing request from the command interpreting section 21, the command processing section 22 requests the device controlling section 23 to control the device 36. For example, the device controlling section 23 obtains device information designated by the command from the device 36.

After receiving the device information from the device controlling section 23, the command processing section 22 sends the device information to the data transmitting section 33. The data transmitting section 33 transmits the device information to the computer 11. With this, processes concerning the command are finished.

As the device 36, there are the HDD 113, the removable medium, the RAM 116, engine boards such as a paper feeding tray, a paper outputting tray, and a toner cartridge, and so on. As the commands for obtaining the device information received from the computer 11, there are commands for obtaining the model name of the printer, the version of software, the remaining number of paper, the available sizes of paper, the available types of paper, the status of the paper outputting tray such as the presence of printed paper and the occupied status of the tray, the remaining amount of toner, the types of fonts, and so on

The device controlling section 23 initializes the device 36 based on the above command and obtains the device information from the device 36 When the image forming apparatus 12 enters an energy saving mode, the device 36 may be in a sleep mode For example, the HDD 113 stops the rotation, and the refresh rate is lowered in the RAM 116. When the device 36 in the sleep mode is required to be operated, the device controlling section 23 starts up the device 36.

The programs for executing the functions of the image forming apparatus 12 can be stored in the NV-RAM 117 or the HDD 113, in addition to in the ROM 112 Moreover, the programs can be stored in a recording medium such as a CD-ROM (not shown), a flexible disk (not shown), or a non-volatile memory such as an EEPROM (not shown), and a memory card (not shown) Further, the programs can be downloaded from the computer 11 via a network (not shown). The programs stored in the recording medium can be read in the image forming apparatus 12 by a driving device (not shown) or a card reader (not shown)

Processes in the image forming apparatus 12 are included in the programs executed by the CPU 113. The processes are described below.

Next, processes for a command transmitted from the computer 11 in the image forming apparatus 12 are described. In the present embodiment, the image forming apparatus 12 executes the command without a time-out problem even if the start-up of the device 36 is needed.

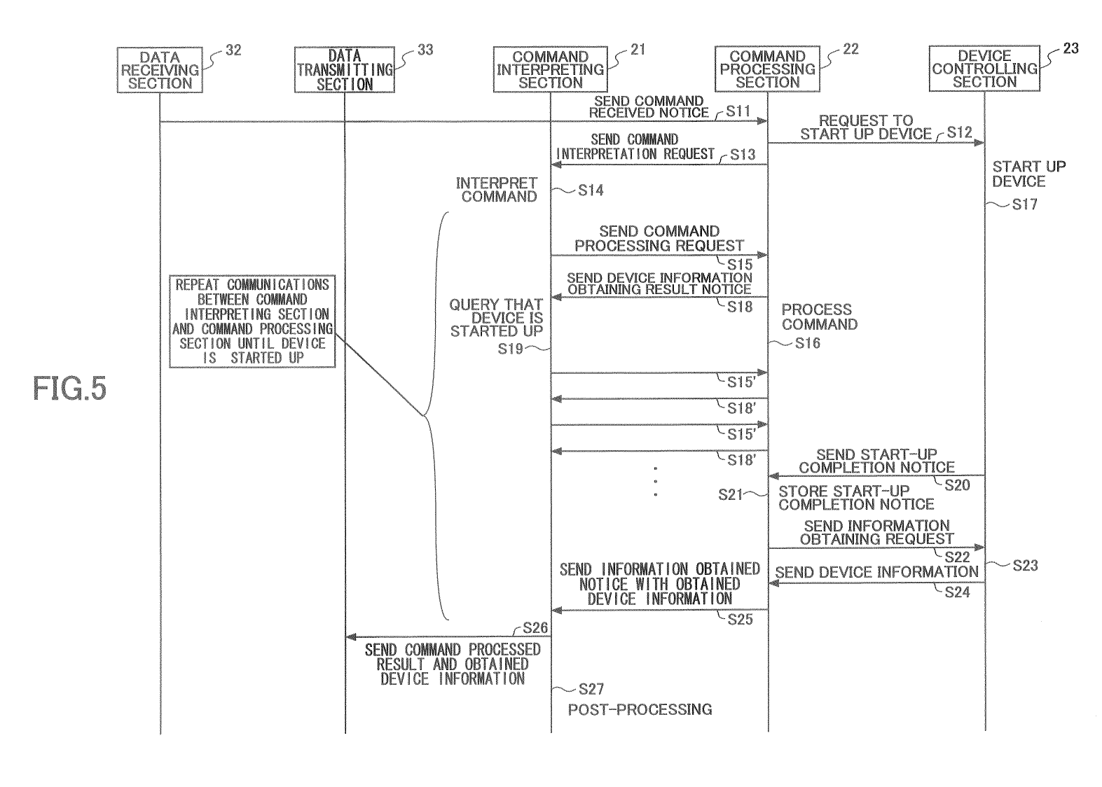

FIG. 5 is a sequence chart showing processes for executing a command in the image forming apparatus 12 according to the first embodiment of the present invention. In FIG. 5, the processes for the command are executed without the time-out problem.

First, the data receiving section 32 receives data including a command from the computer 11 and sends a command received notice to the command processing section 22 (S11). The data includes print data, the command, and so on; however, in the present embodiment, hereinafter the data are simply referred to as the command. The command processing section 22 extracts the command by removing the header and so on after receiving the command received notice.

Next, the command processing section 22 requests the device controlling section 23 to start up the device 36 (S12) That is, before determining whether the device 36 is to be used or the device 36 needs to be started up, the device 36 is started up (Sl7). The device 36 is, for example, the HDD 113.

Next, the command processing section 22 sends a command interpretation request to the command interpreting section 21 (S13). When the command interpreting section 21 receives the command interpretation request, the image forming apparatus 12 accepts the command. That is before starting up the device 36, the command interpretation request is sent to the command interpreting section 21. Therefore, the time-out problem does not occur.

Next, the command interpreting section 21 interprets the command in the command interpretation request (S14). In the interpretation of the command, the contents of the command and the device 36 from which the device information is obtained are analyzed in addition, it is analyzed whether the device 36 becomes (enters) a sleep mode.

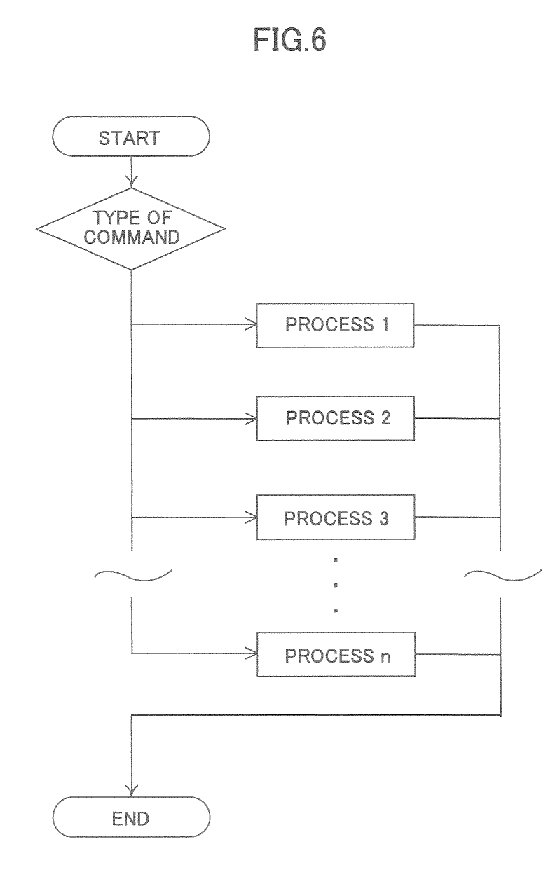

FIG. 6 is a conceptual flowchart showing processes in the command processing section 22 which process is executed based or, a result interpreted by the command interpreting section 21. As shown in FIG. 6, the command processing section 22 executes one of processes from 1 to n based on the received command.

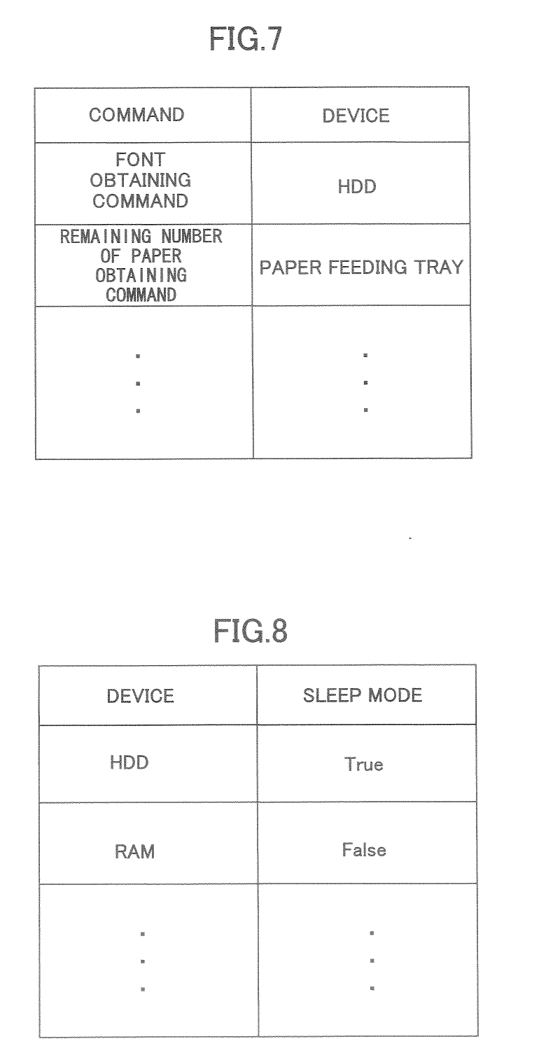

FIG. 7 is a device table showing a relationship between a command and a device according to the first embodiment of the present invention. In FIG. 7, plural devices 36 are described with corresponding commands. The command interpreting section 21 interprets the command by referring to the device table shown in FIG. 7. In FIG. 7, relationships between a font obtaining command and the HDD, and between the remaining number of paper obtaining command and the paper feeding tray are described as examples. The device table is stored in the ROM 112 or the NV-RAM 117. When a command does not need a device, the device does not appear in the device table.

FIG. 8 is a sleep mode table showing a relationship between a sleep mode and a device. In FIG. 8, when the sleep mode is “True”, the device becomes the sleep mode, and when the sleep mode is “False”, the device does not become the sleep mode. That is, when a device is to be used and the device does not become the sleep mode, it is not necessary to start up the device; that is, the device is always operating. Therefore, when the device sleep mode is “True” and the command is to obtain the device information from the device 36, the command interpreting section 21 is put on standby until the device 36 starts up.

Next, returning to FIG. 5, the command interpreting section 21 determines whether the device 36 is needed and becomes the sleep mode for processing the command by referring to the device table shown in FIG. 7 and the sleep mode table shown in FIG. 8. The determined result is stored in the NV-RAM 117.

Next, the command interpreting section 21 sends a command processing request to the command Processing section 22 (S15). The command processing request changes depending on the interpreted result of the command. In the present embodiment, the command is to obtain the device information from the HDD 113.

The command processing section 22 determines whether the HDD has been started up and processes the command when the HDD 113 has been started up (S16). However, in, this case, the HDD 113 has not been started up, that is, a start-up completion notice is not received from the HDD 113 even if the command processing section 22 attempts to obtain the device information from the HDD 113. Therefore, the command processing section 22 sends a device information obtaining result notice to the command interpreting section 21 (S18) in the notice, it is described that obtaining the device information is failed.

Between the command interpreting section 21 and the command processing section 22, sending the command processing request and the device information obtaining result notice is repeated until the HDD 113 starts up (S15′ and S18′). That is, the command interpreting section 21 continues to query the command processing section 22 of the start-up of the HDD 113 until the HDD 113 starts up (S19).

When the HDD 113 starts up, the device controlling section 23 informs the command processing section 22 of the start-up completion notice of the HDD 113 (S20). The command processing section 22 stores the start-up completion notice of the HDD 113 (S21),

When the command processing section 22 receives the command processing request from the command interpreting section 21 after receiving the start-up completion notice of the HDD 113, the command processing section 22 executes a process based on the command in the present embodiment, the command is to obtain the device information from the HDD 133. Therefore, the command processing section 22 sends an information obtaining request to the device controlling section 23 (S22) The device controlling section 23 obtains, for example, font information from the HDD 113 (S23) and sends the font information to the command processing section 22 (S24).

Next, the command processing section 22 sends an information obtained notice with the obtained device information to the command interpreting section 21 (S25). The command interpreting section 21 sends the command processed result and the obtained device information to the data transmitting section 33 (S26). The data transmitting section 33 transmits the device information obtained from the HDD 113 to the computer 11 The command interpreting section 21 executes predetermined post-processing (S27). The predetermined post-processing is described below.

As described above, in the present embodiment before starting up the device 36 (HDD 113), the command processing section 22 sends the command interpretation request to the command interpreting section 21. Therefore, the time-out problem does not occur. In addition, when the device 36 is not to be used or the device 36 does not need to be started up, soon after receiving a command, processes concerning the command are executed. Therefore, a delay caused by waiting for the start-up of the device 36 can be prevented.

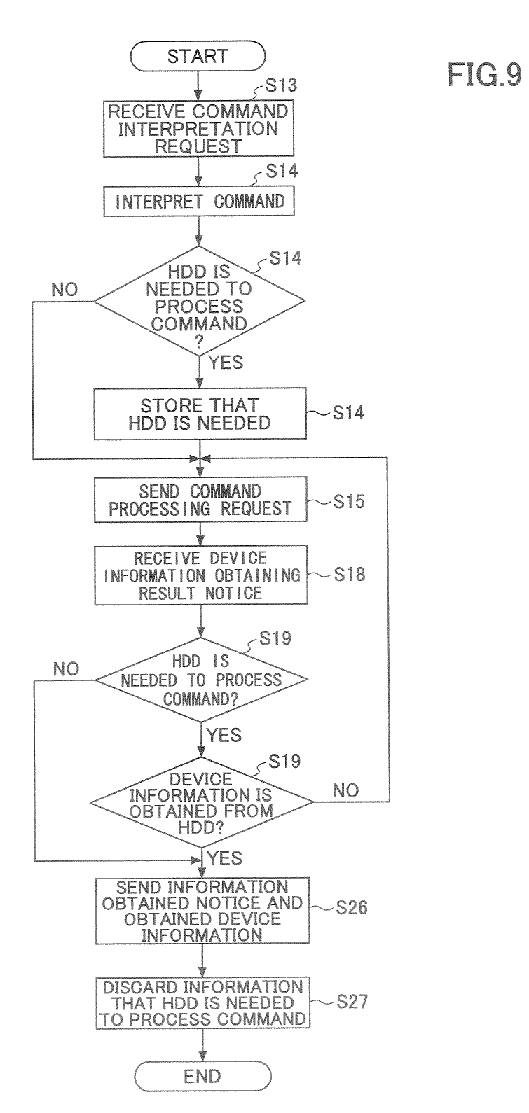

Next, referring to FIGS. 9 through 12, processes in the command interpreting section 21, the command processing section 22, and the device controlling section 23 are described in detail. In FIGS. 9 through 12, a same process as that shown in FIG. 5 has the same step number.

FIG. 9 is a flowchart showing Processes in the command interpreting section 21. First, the command interpreting section 21 receives a command interpretation request from the command processing section 22 (S13) Then, the command interpreting section 21 interprets the command (S14).

In S14, the command interpreting section 21 determines whether the device 36 (HDD 113) is needed to process the command based on the device table shown in FIG. 7 and the interpreted result. When the device 36 is needed, this status is stored in the NV-RAM 117 (S14).

Next, the command interpreting section 21 sends a command processing request to the command processing section 22 (S15) The command interpreting section 21 receives a device information obtaining result notice from the command processing section 22 (S18) Then, the command interpreting section 21 determines again whether the HDD 113 is needed, and when the HDD 113 is needed, it is determined whether device information has been obtained from the HDD 113 (S19)

When the device information is not obtained, the command processing request and the device information obtaining result notice are repeatedly sent.

When the HDD 113 is not needed (NO in upper S19), or the HDD 113 is needed (YES in upper S19) and the device information is obtained from the HDD 113 (YES in lower S19), the command interpreting section 21 sends an information obtained notice and the obtained device information to the data transmitting section 33 (S26). Then the command interpreting section 21 discards information stored in the NV-RAM 117 (S27). In the information, it is described that the HOD 113 is needed to process the command as post-processing (S27).

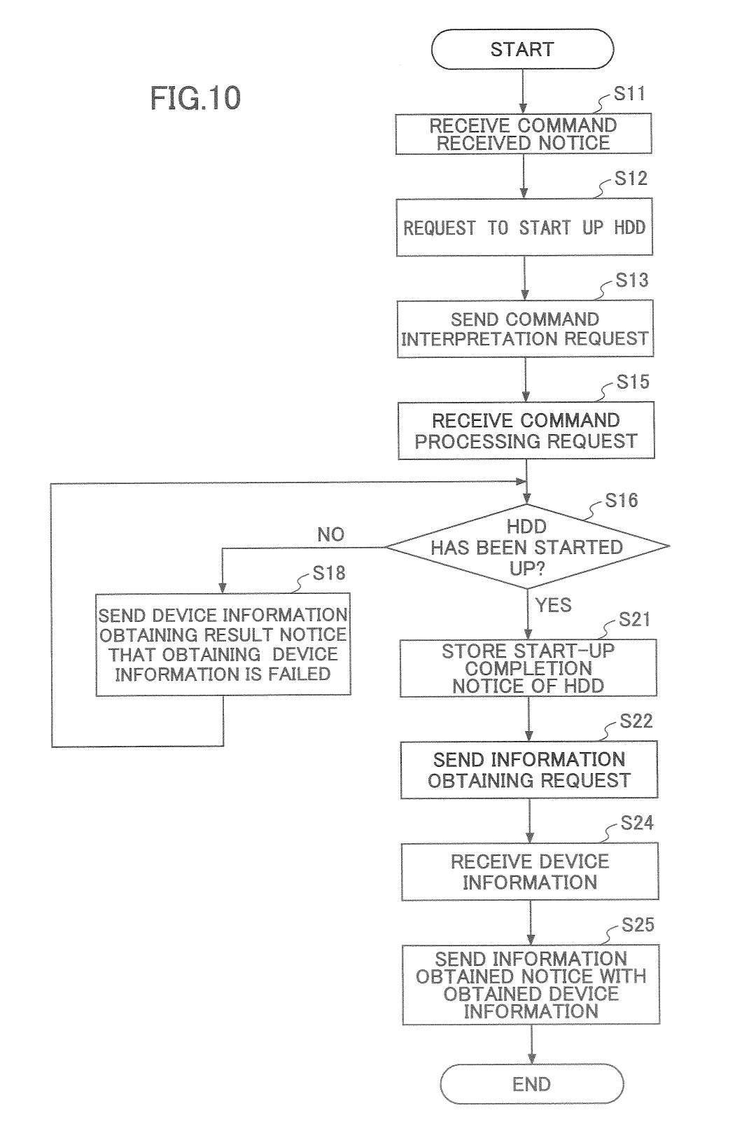

FIG. 10 is a flowchart showing processes in the command processing section 22 when the device 36 must be started up. Firsts the command processing section 22 receives a command received notice from the data receiving section 32 (S11). The command processing section 22 requests the device controlling section 23 to start up the device 36 (HDD 113) (S12). Then, the command processing section 22 sends a command interpretation request to the command interpreting section 21 (S13).

Next, the command processing section 22 receives a command processing request from the command interpreting section 21 (S15). The command processing section 22 determines whether the HDD 113 has been started up (S16). When the HDD 113 has not been started up (NO in S16), the command processing section 22 sends a device information obtaining result notice to the command interpreting section 21 in which notice it is reported that obtaining the device information is failed because the HDD 113 has not been started up (S18) The command processing section 22 continues to send the device information obtaining result notice to the command interpreting section 21 until the HDD 113 starts up.

When the command processing section 22 receives a start-up completion notice of the HDD 113 from the device controlling section 23, the command processing section 22 determines that the HDD 113 is started up (YES in S16). Then the command processing section 22 stores the start-up completion notice of the HDD 113 (S21). Next, the command processing section 22 sends an information obtaining request to the device controlling section 23 (S22). When the command processing section 22 receives the device information from the device controlling section 23, the command processing section 22 sends an information obtained notice with the obtained device information to the command interpreting section 21 (S25)

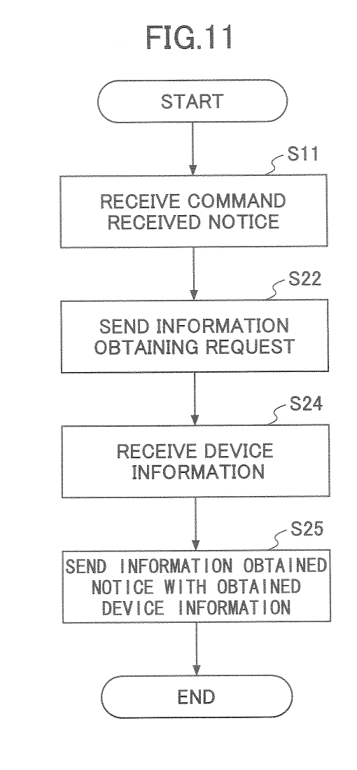

FIG. 11 is a flowchart showing processes in the command processing section 22 when the device 36 does not need to be started up.

First, the command processing section 22 receives a command received notice from the data receiving section 32 (S11). The command processing section 22 sends an information obtaining request to the device controlling section 23 (S22). When the command processing section 22 receives the device information from the device controlling section 23 (S24), the command processing section 22 sends an information obtained notice with the obtained device information to the command interpreting section 21 (S25).

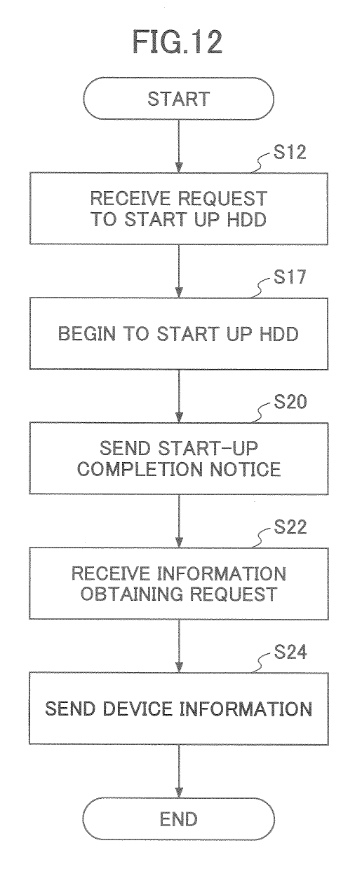

FIG. 12 is a flowchart showing processes in the device controlling section 23. First, when the HDD 113 must be started up for processing the command, the device controlling section 23 receives a request to start up the HDD 113 (S12). Then, the device controlling section 23 begins to start up the HDD 113 (S17). When the HDD 113 is started up, the device controlling section 23 sends a start-up completion notice to the command processing section 22 (S20).

Then, the device controlling section 23 receives an information obtaining request from the command processing section 22 (S22). In this, when the HDD 113 does not need to be started up, the device controlling section 23 receives the information obtaining request without the request to start up the HDD 113 in S12.

The device controlling section 23 obtains, for example, font information (device information) from the HDD 113 and sends the font information to the command processing section 22 (S24).

As described above, in the above processes, the command can be processed without the time-out problem.

In the processes shown in FIGS. 5 and 9 through 12, before sending the command interpretation request to the command interpreting section 21 (S13), the command processing section 22 requests to start up the device 36 (S12). That is, the device 36 is started up before interpreting the command. However, the device 36 can be started up after interpreting the command.

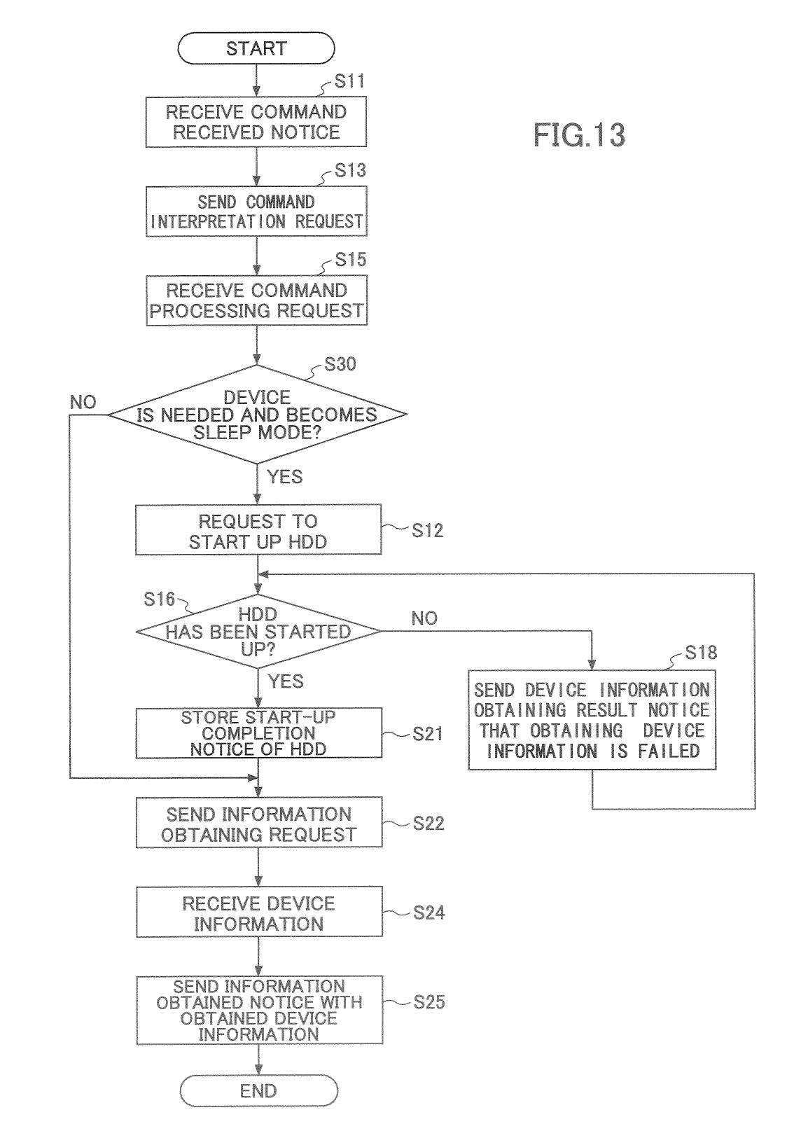

FIG. 13 is a flowchart showing processes in the command processing section 22 in which the device 36 is started up after interpreting the command when the device 36 must be started up. That is, the flowchart shown FIG. 13 is a modified example of that shown in FIG. 10. In FIG. 13, a same process as that shown in FIG. 10 has the same step number.

First, the command processing section 22 receives a command received notice from the data receiving section 32 (S11). Then, the command processing section 22 sends a command interpretation request to the command interpreting section 21 (S13)

The command interpreting section 21 interprets the command, designates a necessary device 36, and analyzes whether the device 36 becomes a sleep mode. When the command processing section 22 receives a command processing request from the command interpreting section 21 (S15), the command processing section 22 determines whether the device 36 is needed and whether the device 36 becomes the sleep mode (S30).

When the device 36 is not needed (NO in S30), the command processing section 22 sends an information obtaining request to the device controlling section 23 (S22). When the command processing section 22 receives the device information from the device controlling section 23 (S24), the command processing section 22 sends an information obtained notice with the obtained device information to the command interpreting section 21 (S25).

When the device 36 is needed and the device 36 becomes the sleep mode (YES in S30), the command processing section 22 requests the device controlling section 23 to start up the device 36 (HDD 113) (S12).

Next, the command processing section 22 determines whether the HDD 113 has been started up (S16). When the HDD 113 has not been started up (NO in S16), the command processing section 22 sends a device information obtaining result notice to the command interpreting section 21 in which notice it is reported that obtaining the device information is failed because the HDD 113 has not been started up (S18). The command processing section 22 continues to send the device information obtaining result notice to the command interpreting section 21 until the HDD 113 starts up.

When the command processing section 22 receives a start-up completion notice of the HDD 113 from the device controlling section 23, the command processing section 22 determines that the HDD 113 is started up (YES in S16). Then the command processing section 22 stores the start-up completion notice of the HDD 113 (S21). Next, the command processing section 22 sends an information obtaining request to the device controlling section 23 (S22). When the command processing section 22 receives the device information from the device controlling section 23 (S24), the command processing section 22 sends an information obtained notice with the obtained device information to the command interpreting section 21 (S25).

As described above, in the processes shown in FIG. 13, only when the device 36 must be started up, the device 36 is started up. Consequently, since the device 36 is not started up in executing a command which does not use the device 36, the power consumption can be reduced. In the processes of the command processing section 22 shown in FIG. 13, the processes of the command interpreting section 21 are the same as the processes shown in FIG. 9; furthers the processes of the device controlling section 23 are the same as the processes shown in FIG. 13. Therefore, the same descriptions are omitted.

### Second Embodiment

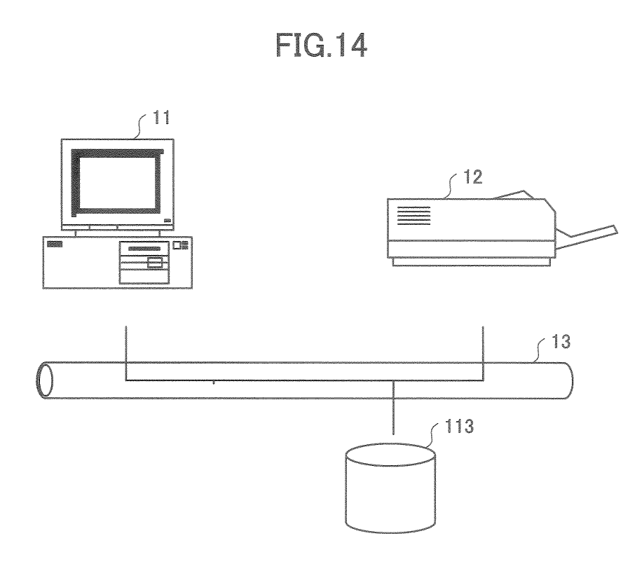

Next, a second embodiment of the present invention is described. In the first embodiment of the present invention, as the device 36, the HDD 113 in the image forming apparatus 12 is used However, in the second embodiment of the present invention, the HDD 113 is connected via a network 13 as an external device. FIG. 14 is a diagram showing a printing system including an image forming apparatus according to the second embodiment of the present invention. As shown in FIG. 14, the printing system includes a computer 11, an image forming apparatus 12, and an HDD 113 connected via a network 13. In FIG. 14, each of the elements has the same reference number as that shown in FIG. 1 and FIG. 3. However, the image forming apparatus 12 shown in FIG. 14 does not include the HDD 113 shown in FIG. 3 The others are the same as those shown in FIG. 3. Further, functions in the image forming apparatus 12 shown in FIG. 14 are the same as those shown in FIG. 4

In FIG. 14, in a case, communications between the HDD 113 (device 36) and the image forming apparatus 12 may be congested In a case where processes based on a received command are executed, when it is determined that the HDD 113 connected via the network 13 is used, the processes are put on standby until the congested communications are decreased. When the HDD 113 is not needed, the processes are normally executed.

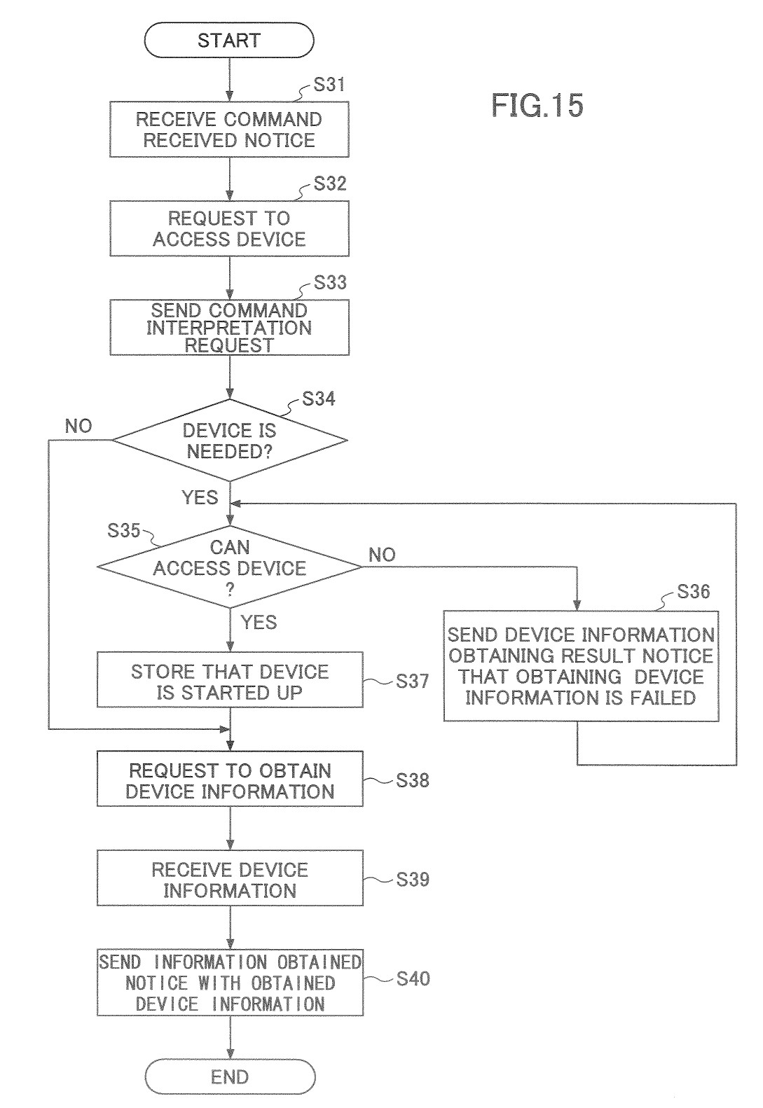

FIG. 15 is a flowchart showing processes in the command processing section 22 when the device 36 connected via the network 13 is used.

First, the command processing section 22 receives a command received notice including a command from the data receiving section 32 (S31)

The command processing section 22 requests the device controlling section 23 to access the device 36 (HDD 113) (S32), that is, the command processing section 22 starts to access the device 36 That is, before determining whether the device 36 connected via the network 13 is to be used and whether the device 36 needs to be started up, the image forming apparatus 12 starts to access the device 36.

Then, the command processing section 22 sends a command interpretation request to the command interpreting section 21 (S33). Therefore, regardless of use or non-use of the device 36, the command interpretation request is sent to the command interpreting section 21. Consequently, the time-out problem does not occur.

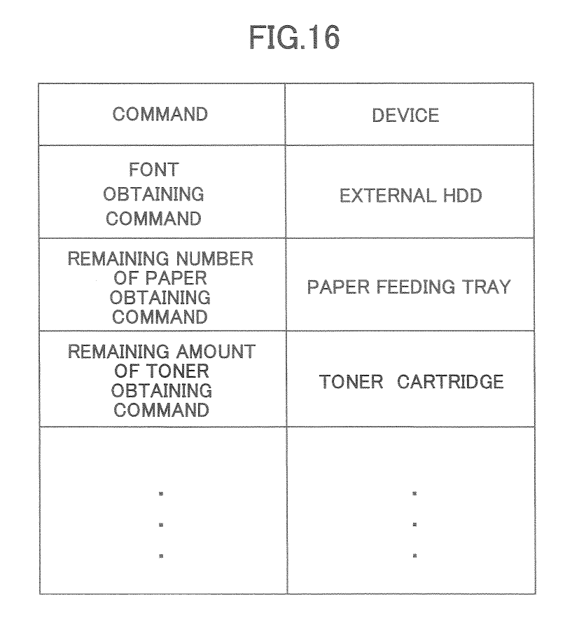

Next, the command interpreting section 21 analyzes the command in the command interpretation request. FIG. 16 is a device table showing a relationship between a command and a device according to the second embodiment of the present invention. In FIG. 16, the relationships between a font obtaining command and an external HDD, between the remaining number of paper obtaining command and a paper feeding tray, and between the remaining amount of toner obtaining command and a toner cartridge are described.

In the present embodiments generally, the HDD 113 connected via the network 13 does not become a sleep mode. Therefore, the sleep mode table is not used. However, the sleep mode table can be used when an external device such as an external RAM (not shown) is used instead of the HDD 113.

The command interpreting section 21 interprets the command by referring to the device table shown in FIG. 16.

Returning to FIG. 15, the processes are described. The command processing section 22 determines whether the device 36 (HDD 113) connected via the network 13 is needed based on the interpreted result in the command interpreting section 21 (S34).

When the HDD 113 is not needed (NO in S34), the command processing section 22 requests the device controlling section 23 to obtain the device information from the device 36 (S38). When the command processing section 22 receives the device information from the device controlling section 23 (S39), the command processing section 22 sends a device information obtained notice with the obtained device information to the command interpreting section 21 (S40).

When the HDD 113 is needed (YES In S34), the command processing section 22 determines whether the image forming apparatus 12 can access the HDD 113 connected via the network 13 (S35). When the image forming apparatus 12 cannot access the HDD 113 (NO in S35), the command processing section 22 informs the command interpreting section 21 that the device information cannot be obtained because the HDD 113 is not started up (S36). The command processing section 22 continues to send the device information obtaining status until the HDD 113 is started up.

When the image forming apparatus 12 can access the HDD 113 (YES in S35), that is, the device controlling section 23 informs the command processing section 22 that the image forming apparatus 12 can access the HDD 113, the command processing section 22 stores that the HDD 113 is started up (S37) Then the command processing section 22 requests the device controlling section 23 to obtain the device information (S38). When the command processing section 22 receives the device information from the device controlling section 23 (S39), the command processing section 22 sends a device information obtained notice with the obtained device information to the command interpreting section 21 (S40).

As described above, according to the second embodiment of the present invention, even if the HDD 113 (device 36) is connected to the image forming apparatus 12 via the network 13, the time-out problem can be prevented in the processes shown in FIG. 15, the access to the HDD 113 connected via the network 13 is started before determining whether the HDD 113 is needed. However, the access to the HDD 113 connected via the network 13 can be started after determining whether the HDD 113 is needed.

### Third Embodiment

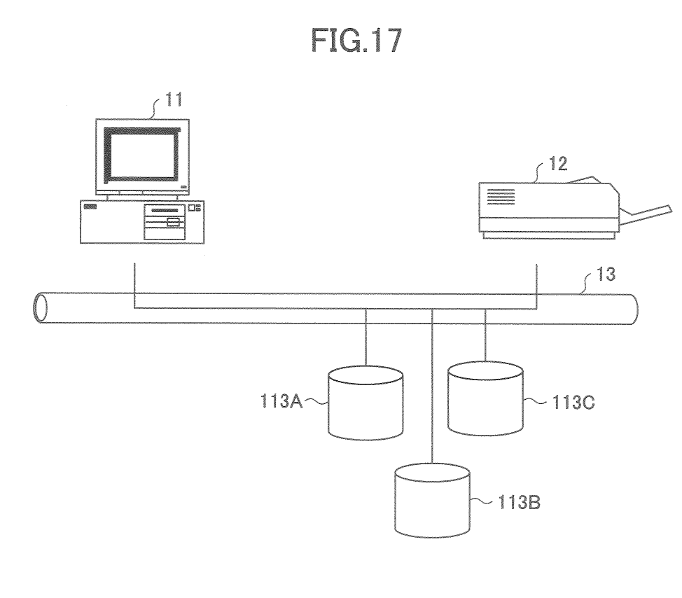

Next, a third embodiment of the present invention is described. FIG. 17 is a diagram showing a printing system including an image forming apparatus according to the third embodiment of the present invention. As shown in FIG. 17, the printing system includes an image forming apparatus 12, a computer 11, and plural HDDs 113A, 113B, and 113C connected via a network 13. That is, in the third embodiment of the present invention, compared with the second embodiment of the present invention, the plural external HDDs 113A, 113B, and 113C (devices 36) are connected to the image forming apparatus 12 via the network 13.

In each of the HDDs 113A through 113C, the same device information is stored Therefore, in a case where communications between one of the HDDs 113A through 113C and the image forming apparatus 12 are congested, when the image forming apparatus 12 selects one of the HDDs 113A through 113C whose communications are not congested, the image forming apparatus can access the selected one of the HDDs 113A through 113C.

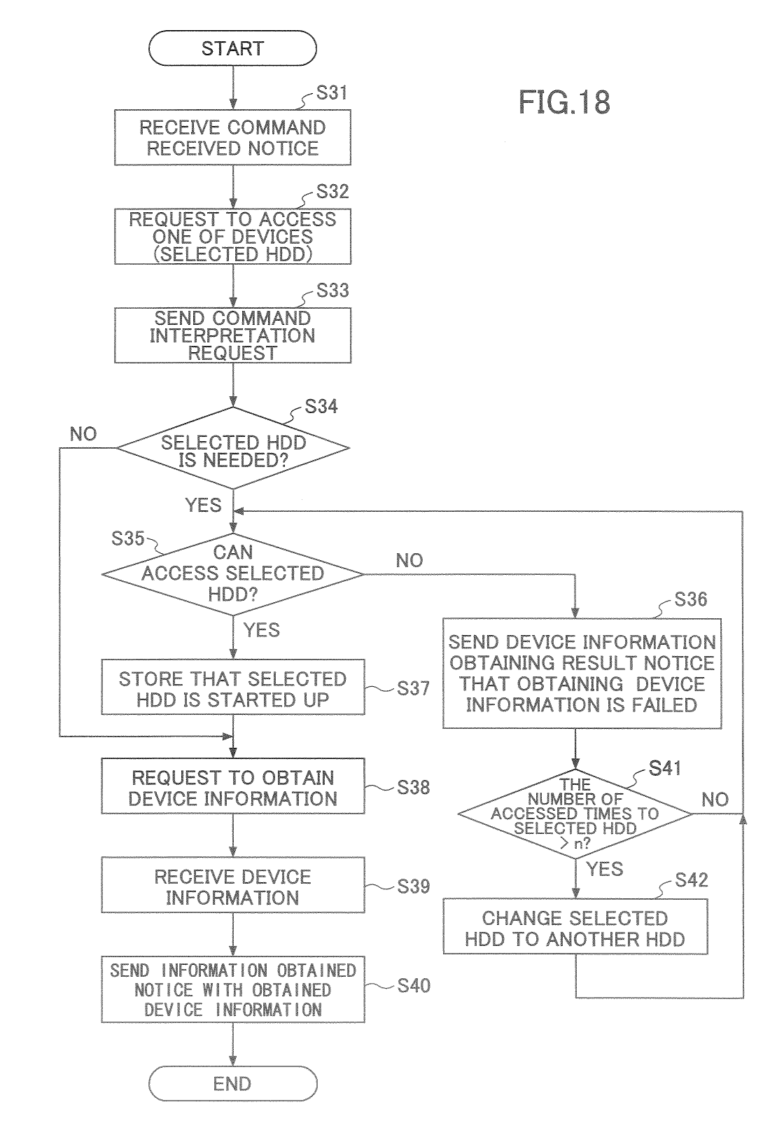

FIG. 18 is a flowchart showing processes in the command processing section 22 when the devices 36 connected via the network 13 are used. In FIG. 18 the devices 36 are the HDDs 113A through 113C. In additions a same process as that shown in FIG. 15 has the same step number.

First, the command processing section 22 receives a command received notice from the data receiving section 32 (S31).

The command processing section 22 requests the device controlling section 23 to access one of the devices 36 (selected device 36) (S32). In the following, the HDD 113 is used without the suffix. That is, the command processing section 22 starts to access the selected HDD 113. In other words, before determining whether the selected HDD 113 connected via the network 13 is to be used and whether the selected HDD 113 needs to be started up, the image forming apparatus 12 starts to access the selected HDD 113.

Then the command processing section 22 sends a command interpretation request to the command interpreting section 21 (S33). Therefore, regardless of use or non-use of the selected HDD 113, the command interpretation request is sent to the command interpreting section 21. Consequently, the time-out problem does not occur.

Next, the command interpreting section 21 analyzes the command in the command interpretation request. When analyzing (interpreting) the command, the command interpreting section 21 refers to the device table shown in FIG. 16.

The command processing section 22 determines whether the selected HDD 113 connected via the network 13 is needed based on the interpreted result in the command interpreting section 21 (S34).

When the selected HDD 113 is not needed (NO in S34), the command processing section 22 requests the device controlling section 23 to obtain the device information from another device 36 (another HDD 113) (S38). When the command processing section 22 receives the device information from the device controlling section 23 (S39), the command processing section 22 sends a device information obtained notice with the obtained device information to the command interpreting section 21 (S40).

When the selected HDD 113 is needed (YES in S34), the command processing section 22 determines whether the image forming apparatus 12 can access the selected HDD 13 connected via the network 13 (S35). When the image forming apparatus 12 cannot access the selected HDD 113 (NO in S35), the command processing section 22 informs the command interpreting section 21 that the device information cannot be obtained because the selected HDD 113 is not started up (S36).

Next, the command processing section 22 determines whether the number of accessed times to the selected HDD 113 is greater than a predetermined number “n” (S41). That is, the command processing section 22 determines the number of times accessed. The number of seconds to be taken for completion of the access can be obtained from the number of times accessed. Therefore, the congested status between the selected HDD 113 and the image forming apparatus 12 can be estimated.

A When the number of accessed times to the selected HDD 113 is the predetermined number “n” or less (NO in S41), the command processing section 22 determines again whether the image forming apparatus 12 can access the selected HDD 113 connected via the network 13 (S35) When the image forming apparatus 12 cannot access the selected HDD 113 (NO in S35), the command processing section 22 informs the command interpreting section 21 that the device information cannot be obtained because the selected HDD 113 is not started up (S36) The command processing section 22 continues to send the device information obtaining status until the selected HDD 113 is started up.

When the number of times accessing the selected HDD 113 is greater than the predetermined number “n” (YES in S41), the command processing section 22 requests the device controlling section 23 to change the selected HDD 113 to another HDD 113 to be accessed (S42). In this, another HDD 113 is referred to as the changed HDD 113.

Then the process of the command processing section 22 returns to the process in S35. The command processing section 22 determines whether the image forming apparatus 12 can access the changed HDD 113 connected via the network 13 (S35).

When the image forming apparatus 12 can access the changed HDD 113 (YES in S35), that is, the device controlling section 23 informs the command processing section 22 that the image forming apparatus 12 can access the changed HDD 113, the command processing section 22 stores that the changed HDD 113 is started up (S37). Then the command processing section 22 requests the device controlling section 23 to obtain the device information from the changed HDD 113 (S38). When the command processing section 22 receives the device information from the device controlling section 23 (S39), the command processing section 22 sends a device information obtained notice with the obtained device information to the command interpreting section 21 (S40).

As described above, according to the third embodiment of the present invention, even if the devices 36 are connected to the image forming apparatus 12 via the network 13, the time-out problem can be prevented. In addition, since the plural devices 36 (HDDs 113A through 113C) are connected to the image forming apparatus 12 via the network 13, the image forming apparatus 12 can select one of the devices 36 whose communication congestion is low and the processes in the image forming apparatus 12 can be executed at high speed.

### Fourth Embodiment

Next, a fourth embodiment of the present invention is described. In the first through the three embodiments of the present invention, device information necessary for processing a command is directly obtained from a device 36; however, the device information necessary for processing the command can be stored in a cache memory. When the device information is stored in the cache memory, it is not necessary to start up the device 36, not necessary to wait for until the device 36 is started up, and not necessary to access the device 36. That is, the necessary device information can be obtained from the cache memory. That is, in the fourth embodiment of the present invention, a cache memory is used.

In the fourth embodiment of the present invention, as the printing system, any one of the printing systems in the first, second, and third embodiments of the present invention can be used. That is, the image forming apparatus 12 can includes the device 36, or can use one or more devices 36 connected via the network 13. Therefore, the fourth embodiment of the present invention is described by using the printing system in the first embodiment of the present invention.

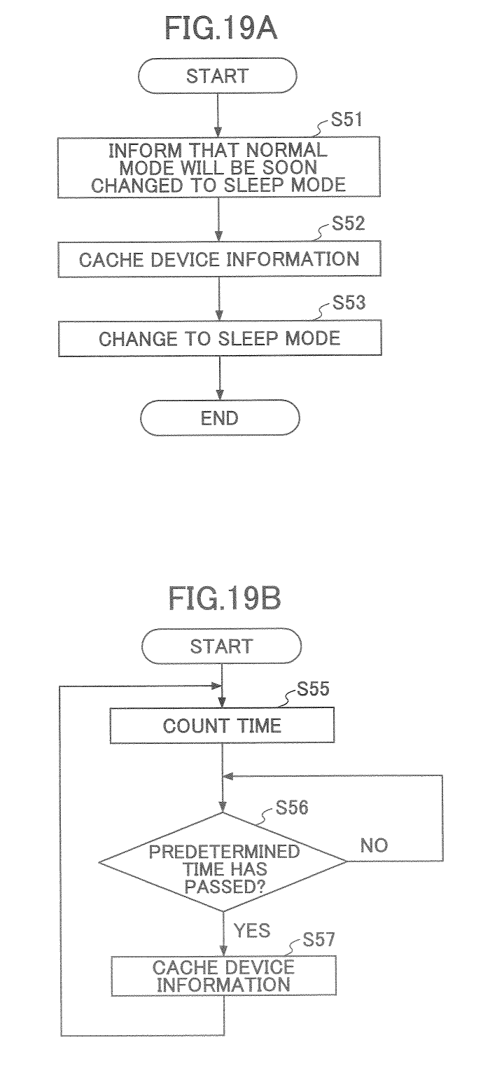

FIG. 19A is a flowchart showing processes for caching device information in a cache memory by the device controlling section 23 Since it can be detected that the device 36 becomes a sleep mode by a timer or control of the image forming apparatus 12, the device information in the device 36 can be cached right before the device 36 becomes the sleep mode.

First, in FIG. 19A, the device controlling section 23 informs the command processing section 22 that the normal mode will soon be changed to the sleep mode (S51). With this, the command processing section 22 can detect that the device 36 will soon be in the sleep mode.

Next, the device controlling section 23 extracts the device information stored in the device 36 and caches the device information in a cache memory (S52). As the cache memory, the RAM 115, the optional RAM 119, or the NV-RAM 119 can be used.

Then the device controlling section 23 changes the normal mode of the device 36 to the sleep mode (S53). Therefore, when the device information is stored in the cache memory, the image forming apparatus 12 can process a command without the time-out problem by obtaining the device information from the cache memory.

FIG. 19B is another flowchart showing processes for caching device information in a cache memory by the device controlling section 23. In FIG. 19B, the device information is stored in a cache memory regardless of the mode of the device 36.

In FIG. 19B, the device controlling section 23 starts to count time right after finishing the access to the device 36 (S55). Then it is determined whether a predetermined time has passed (S56). When the predetermined time has passed (YES in S56), the device controlling section 23 stores the device information in a cache memory by extracting the device information from the device 36 (S57).

As shown in FIG. 19B, when the device information is stored at a certain interval, newest device information is stored in the cache memory. With this, the number of accessing times to the device 36 can be reduced.

In either case of the processes shown in FIGS. 19A and 19B the device information of all the devices 36 can be cached. However, in the present embodiment, the device information of a part of the devices 36 is cached due to a capacity limit of the cache memory.

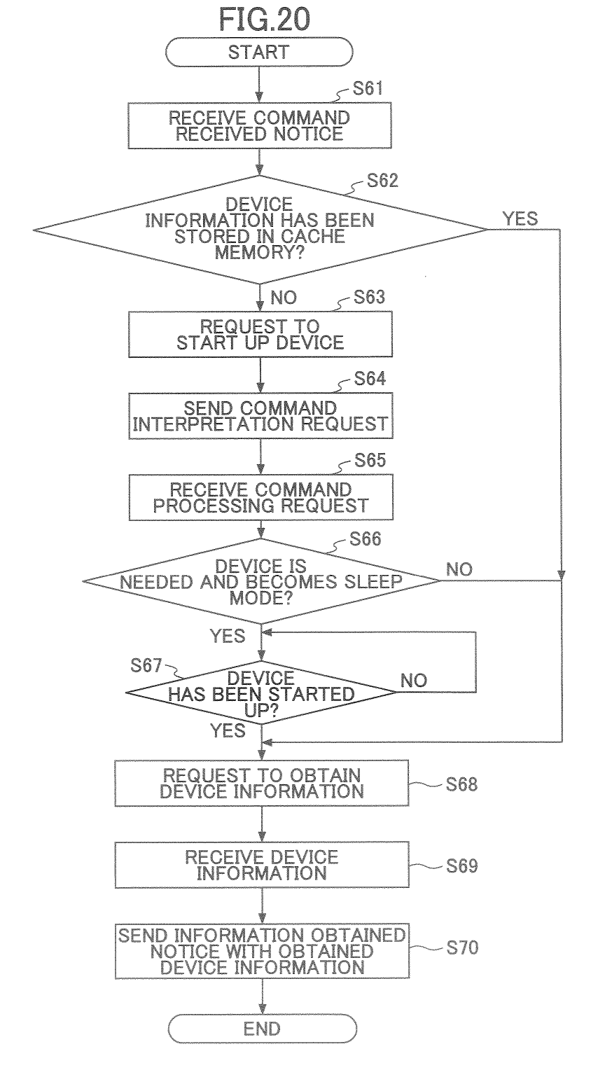

FIG. 20 is a flowchart showing processes in the command processing section 22 when the device information is stored in a cache memory according to the fourth embodiment of the present invention.

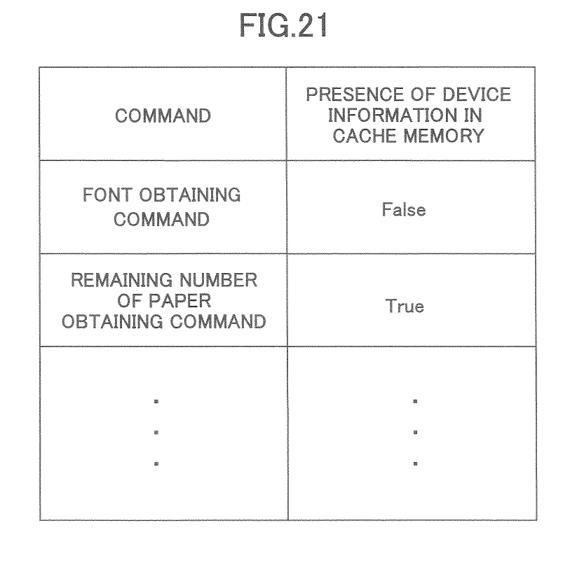

In FIG. 20, first the command processing section 22 receives a command received notice including a command from the data receiving section 32 (S61). Then it is determined whether the command is processed based on the device information stored in the cache memory that is, it is determined whether the device information has been stored in the cache memory (S62). In the process of S62, a device information presence table shown in FIG. 21 is used.

FIG. 21 is the device information presence table according to the fourth embodiment of the present invention. The table shown in FIG. 21 is a cache memory utilizing table. In FIG. 21, when the presence of the device information in the cache memory is “False”, the command processing section 22 directly obtains the device information from the device 36, and when the presence of the device information in the cache memory is “True”, the command processing section 22 obtains the device information from the cache memory. From the table shown in FIG. 21, when the command is a font obtaining command, the command processing section 22 obtains the device information from the device 36, and when the command is a remaining number of paper obtaining command, the command processing section 22 obtains the device information from the cache memory.

In the cache memory, generally, device information of the devices 36 whose memory capacity is small is stored. In the device information presence table shown in FIG. 21, when the device information of the device 36 is matched with the device information in the cache memory, “True”, is set. It is preferable that the device information in the cache memory be updated every time when the device controlling section 23 accesses the device 36. For example by using LRU (least recently used), old device information is removed from the cache memory and new device information is stored in the cache memory.

Returning to FIG. 20, the processes are described. When the device information has been stored in the cache memory (YES in S62), the command processing section 22 sends an information obtaining request to the device controlling section 23 (S68). The command processing section 22 receives the device information from the device controlling section 23 which information is obtained from the cache memory (S69). In addition, the command processing section 22 sends an information obtained notice with the obtained device information to the command interpreting section 21 (S70). As described above, when the device information in the cache memory is used, the time-out problem does not occur even if the device 36 is in the sleep mode.

When the device information has not been stored in the cache memory (NO in S62), the command processing section 22 requests the device controlling section 23 to start up the device 36 (S63). That is, before determining whether the device 36 is to be used and whether the device 36 must be started up, the start-up of the device 36 is begun.

Then, the command processing section 22 sends a command interpretation request to the command interpreting section 21 (S64). The command interpreting section 21 interprets a device 36 which needs for processing the command and interprets whether the device 36 becomes a sleep mode. The command processing section 22 receives a command processing request from the command interpreting section 21 (S65).

The command processing section 22 determines whether the device 36 is needed and whether the device 36 becomes the sleep mode (S66). When the device 36 is not needed (NO in S66), the command processing section 22 sends an information obtaining request to the device controlling section 23 (S68). The device controlling section 23 obtains the device information from the cache memory. The command processing section 22 receives the device information from device controlling section 23 (S69). In addition, the command processing section 22 sends an information obtained notice with the obtained device information to the command interpreting section 21 (S70).

When the device 36 is needed and the device 36 becomes the sleep mode (YES in S66), the command processing section 22 determines whether the device 36 (HDD 113) has been started up (S67).

When the device 36 (HDD 113) has not been started up (NO in S67), the command processing section 22 continues to check until the device 36 is started up. When the device 36 has been started up (YES in S67), the command processing section 22 sends an information obtaining request to the device controlling section 23 (S68). The command processing section 22 receives the device information from the device controlling section 23 which information is obtained from the device 36 (S69). In additions the command processing section 22 sends an information obtained notice with the obtained device information to the command interpreting section 21 (S70).

As described above, according to the present embodiment, when the device information in the cache memory is used, the time-out problem does not occur. In addition, when the device information in the device 36 is used, the command processing section 22 sends the command interpretation request to the command interpreting section 21 before starting up the device 36. Therefore, the time-out problem does not occur.

### Fifth Embodiment

Next, a fifth embodiment of the present invention is described. In the fourth embodiment of the present invention, the device information presence table shown in FIG. 21 is used when the device information in the cache memory is used. However, in the fifth embodiment of the present invention, it is determined whether the device information in the cache memory is used based on whether device information designated by a command is unchangeable. In the fifth embodiment of the present invention, the printing system is the same as that in the fourth embodiment of the present invention.

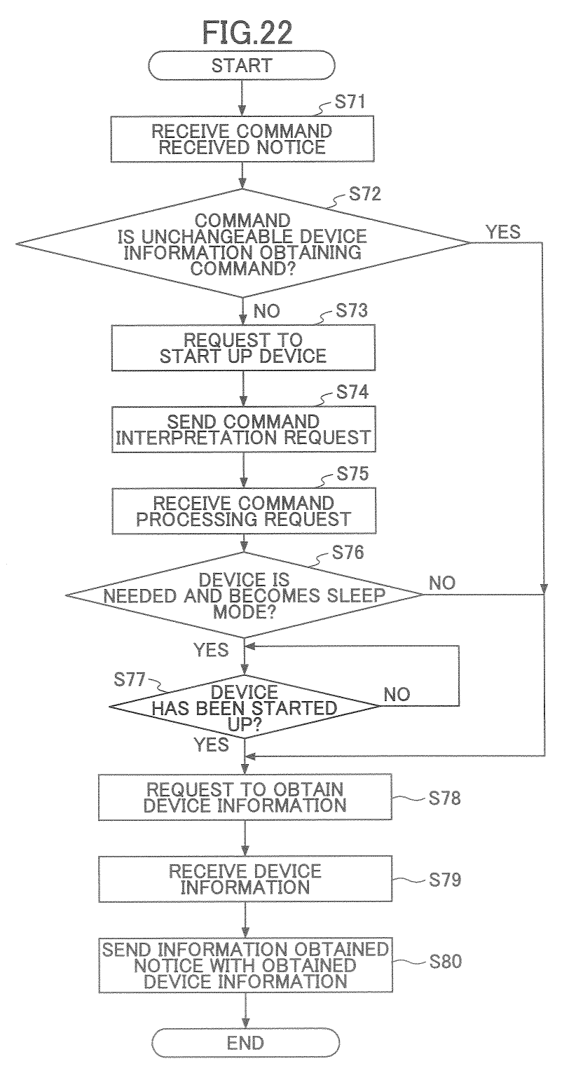

FIG. 22 is a flowchart showing processes in the command processing section 22 when the device information is stored in the cache memory according to the fifth embodiment of the present invention.

In FIG. 22, first, the command processing section 22 receives a command received notice including a command from the data receiving section 32 (S71). The command processing section 22 determines whether the command is an unchangeable device information obtaining command which unchangeable device information is stored in a cache memory (S72).

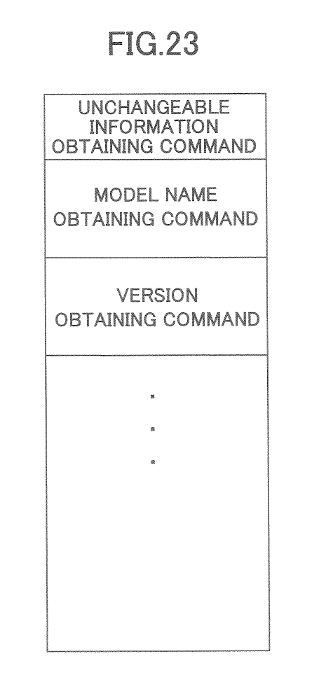

FIG. 23 is an unchangeable device information obtaining command table according to the fifth embodiment of the present invention. The table shown in FIG. 23 is a cache memory utilizing table. In the unchangeable device information obtaining command table shown in FIG. 23, commands for obtaining unchangeable device information in the image forming apparatus 12 are stored in a cache memory. The unchangeable device information is not, for example, the remaining number of paper information which changes, but, for example, model name information and version information of firmware of the image forming apparatus 12 which cannot be changed. In FIG. 23, as examples, a model name obtaining command and a version obtaining command are shown as the unchangeable device information obtaining commands. That is, the model name and the version are not changed.

The following processes are almost similar to the processes shown in FIG. 20.

When the command is the unchangeable device information obtaining command (YES in S72), the command processing section 22 sends an information obtaining request to the device controlling section 23 (S78). The command processing section 22 receives the device information from the device controlling section 23 which information is obtained from the cache memory (S79). In addition, the command processing section 22 sends an information obtained notice with the obtained device information to the command interpreting section 21 (S80). As described above, when the device information in the cache memory is used, the time-out problem does not occur even if the device 36 is in the sleep mode.

When the command is not the unchangeable device information obtaining command (NO in S72), the command processing section 22 requests the device controlling section 23 to start up the device 36 (S73). That is, before determining whether the device 36 is to be used and whether the device 36 must be started up, the start-up of the device 36 is begun.

Then, the command processing section 22 sends a command interpretation request to the command interpreting section 21 (S74). The command interpreting section 21 interprets a device 36 which is needed for processing the command and interprets whether the device 36 becomes a sleep mode. The command processing section 22 receives a command processing request from the command interpreting section 21 (S75).

The command processing section 22 determines whether the device 36 is needed and the device 36 becomes the sleep mode (S76). When the device 36 is not needed (NO in S76), the command processing section 22 sends an information obtaining request to the device controlling section 23 (S78). The device controlling section 23 obtains the device information from the cache memory. The command processing section 22 receives the device information from device controlling section 23 (S79). In addition, the command processing section 22 sends an information obtained notice with the obtained device information to the command interpreting section 21 (S80).

When the device 36 is needed and the device 36 becomes the sleep mode (YES in S76), the command processing section 22 determines whether the device 36 (HDD 113) has been started up (S77).

When the device 36 (HDD 113) has not been started up (NO in S77), the command processing section 22 continues to check until the device 36 is started up. When the device 36 is started up (YES in S77), the command processing section 22 sends an information obtaining request to the device controlling section 23 (S78). The command processing section 22 receives the device information from the device controlling section 23 which information is obtained from the device 36 (S79). In addition, the command processing section 22 sends an information obtained notice with the obtained device information to the command interpreting section 21 (S80).

As described above, according to the present embodiment, when the unchangeable device information is obtained, the device information is obtained from the cache memory; therefore, the time-out problem does not occur. In addition, when the device information in the device 36 is used, the command processing section 22 sends the command interpretation request to the command interpreting section 21 before starting up the device 36. Therefore, the time-out problem does not occur.

### Sixth Embodiment

Next, a sixth embodiment of the present invention is described. In the fifth embodiment of the present invention, the device information which is used for processing the command is determined based on the unchangeable device information.

However, in the sixth embodiment of the present invention, it is determined whether the device information in the cache memory is used based on a source of the command. In the sixth embodiment of the present invention, the printing system is the same as that in the fourth embodiment of the present invention.

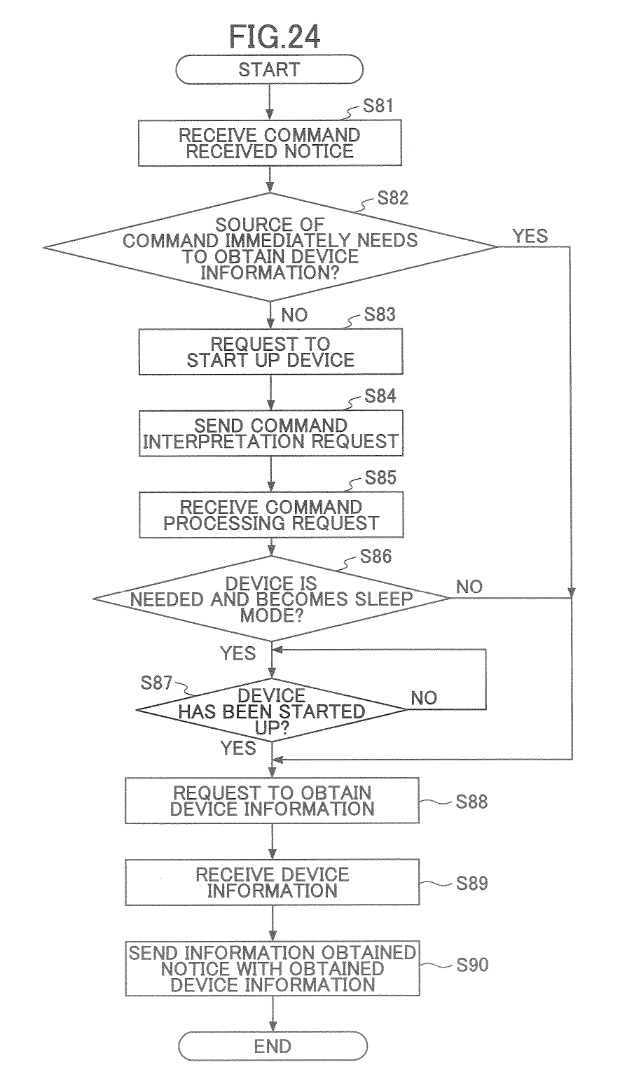

FIG. 24 is a flowchart showing processes in the command processing section 22 when the device information is stored in the cache memory according to the sixth embodiment of the present invention.

In FIG. 24, first, the command processing section 22 receives a command received notice including a command from the data receiving section 32 (S81). The command processing section 22 determines whether a source of the command immediately needs to obtain device information for processing the command (S82). In this, the source of the command is, for example, the computer 11.

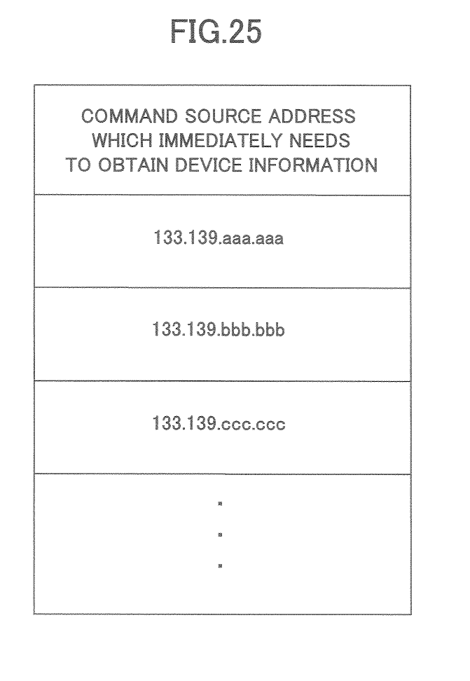

FIG. 25 is a command source address table according to the sixth embodiment of the present invention. The table shown in FIG. 25 is a cache memory utilizing table. In FIG. 25, command source addresses which need to immediately obtain device information are shown. The addresses shown in FIG. 25 are IP (Internet Protocol) addresses. For example, when a command is transmitted from an address “133.139.aaa.aaa”, device information stored in a cache memory is immediately obtained. The IP address is included in the header of the command transmitted from the computer 11.

The following processes are almost similar to the processes shown in FIG. 20.

When the source of the command immediately needs to obtain device information for processing the command (YES in S82), the command processing section 22 sends an information obtaining request to the device controlling section 23 (S88). The command processing section 22 receives the device information from the device controlling section 23 which information is obtained from the cache memory (S89). In additions the command processing section 22 sends an information obtained notice with the obtained device information to the command interpreting section 21 (S90). As described above, when the device information in the cache memory is used, the time-out problem does not occur even if the device 36 is in the sleep mode.

When the source of the command does not immediately need to obtain device information for processing the command (NO in S82), the command processing section 22 requests the device controlling section 23 to start up the device 36 (S83) That is, before determining whether the device 36 is to be used and whether the device 36 must be started up, the start-up of the device 36 is begun.

Then, the command processing section 22 sends a command interpretation request to the command interpreting section 21 (S84). The command interpreting section 21 interprets a device 36 which is needed for processing the command and interprets whether the device 36 becomes a sleep mode. The command processing section 22 receives a command processing request from the command interpreting section 21 (S85).

The command processing section 22 determines whether the device 36 is needed and the device 36 becomes the sleep mode (S86). When the device 36 is not needed (NO in S86), the command processing section 22 sends an information obtaining request to the device controlling section 23 (S88). The device controlling section 23 obtains the device information from the cache memory. The command processing section 22 receives the device information from device controlling section 23 (S89). In additions the command processing section 22 sends an information obtained notice with the obtained device information to the command interpreting section 21 (S90).

When the device 36 is needed and the device 36 becomes the sleep mode (YES in S86), the command processing section 22 determines whether the device 36 (HDD 113) has been started up (S87).

When the device 36 (HDD 113) has not been started up (NO in S87), the command processing section 22 continues to check until the device 36 is started up. When the device 36 is started up (YES in S87), the command processing section 22 sends an information obtaining request to the device controlling section 23 (S88). The command processing section 22 receives the device information from the device controlling section 23 which information is obtained from the device 36 (S89). In addition, the command processing section 22 sends an information obtained notice with the obtained device information to the command interpreting section 21 (S80).

As described above, according to the present embodiment, it is determined whether the device information in the cache memory is used based on the command from the source. Therefore, when the device information in the cache memory is used, it is not needed to start up the device 36. Consequently, the time-out problem does not occur. In addition, when the device information in the device 36 is used, the command processing section 22 sends the command interpretation request to the command interpreting section 21 before starting up the device 36 Therefore, the time-out problem does not occur.

### Seventh Embodiment

Next, a seventh embodiment of the present invention is described in the sixth embodiment of the present invention, the device information which is used for processing the command is determined based on the source of the command.

However, in the seventh embodiment of the present invention, it is determined whether the device information in the cache memory is used based on a command. In the seventh embodiment of the present invention, the printing system is the same as that in the fourth embodiment of the present invention.

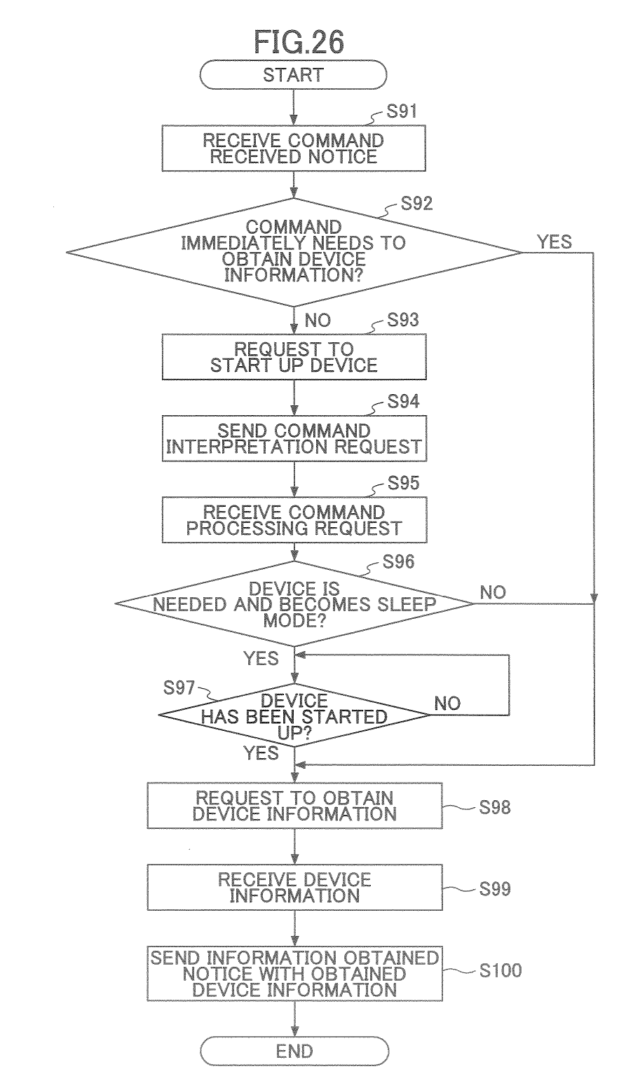

FIG. 26 is a flowchart showing processes in the command processing section 22 when the device information is stored in the cache memory according to the seventh embodiment of the present invention.

In FIG. 26, first, the command processing section 22 receives a command received notice including a command from the data receiving section 32 (S91). The command processing section 22 determines whether the received command immediately needs to obtain device information for processing the command (S92).

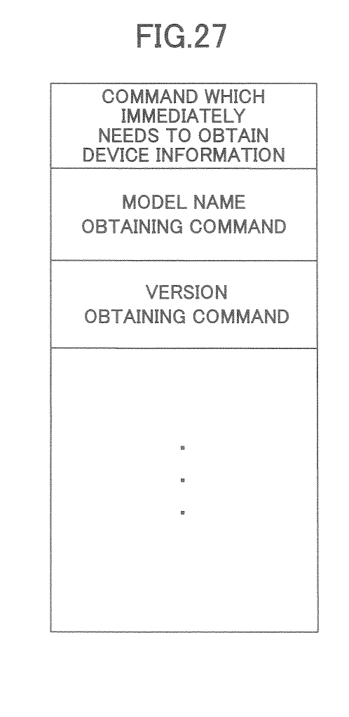

FIG. 27 is a command table according to the seventh embodiment of the present invention. The table shown in FIG. 27 is a cache memory utilizing table. In FIG. 27, commands which immediately need to obtain device information are shown, for example, a model name obtaining command and a version obtaining command are shown. That is, in FIG. 27, commands for obtaining the unchangeable device information are shown which information is frequently used. When the model name obtaining command is transmitted from the computer 11, the image forming apparatus 12 immediately uses device information stored in the cache memory.

The following processes are almost similar to the processes shown in FIG. 20.

When the command immediately needs to obtain device information (YES in S92), the command processing section 22 sends an information obtaining request to the device controlling section 23 (S98). The command processing section 22 receives the device information from the device controlling section 23 which information is obtained from the cache memory (S99). In addition, the command processing section 22 sends an information obtained notice with the obtained device information to the command interpreting section 21 (S30). As described above, when the device information in the cache memory is used, the time-out problem does not occur even if the device 36 is in the sleep mode.

When the command does not immediately need to obtain device information (NO in S92), the command processing section 22 requests the device controlling section 23 to start up the device 36 (S93). That is, before determining whether the device 36 is to be used and whether the device 36 must be started up, the start-up of the device 36 is begun.

Then, the command processing section 22 sends a command interpretation request to the command interpreting section 21 (S94), The command interpreting section 21 interprets a device 36 which is needed for processing the command and interprets whether the device 36 becomes a sleep mode. The command processing section 22 receives a command processing request from the command interpreting section 21 (S95).

The command processing section 22 determines whether the device 36 is needed and the device 36 becomes the sleep mode (S96). When the device 36 is not needed (NO in S96), the command processing section 22 sends an information obtaining request to the device controlling section 23 (S98). The device controlling section 23 obtains the device information from the cache memory. The command processing section 22 receives the device information from device controlling section 23 (S99). In addition, the command processing section 22 sends an information obtained notice with the obtained device information to the command interpreting section 21 (S100).

When the device 36 is needed and the device 36 becomes the sleep mode (YES in S96), the command processing section 22 determines whether the device 36 (HDD 113) has been started up (S97).

When the device 36 (HDD 113) has not been started up (NO in S97), the command processing section 22 continues to check until the device 36 is started up When the device 36 is started up (YES in S97), the command processing section 22 sends an information obtaining request to the device controlling section 23 (S98). The command processing section 22 receives the device information from the device controlling section 23 which information is obtained from the device 36 (S99). In addition, the command processing section 22 sends an information obtained notice with the obtained device information to the command interpreting section 21 (S100).

As described above, according to the present embodiment, it is determined whether the device information in the cache memory is to be used based on the command. Therefore, when the device information in the cache memory is to be used it is not needed to start up the device 36 Consequently, the time-out problem does not occur. In addition, when the device information in the device 36 is to be used, the command processing section 22 sends the command interpretation request to the command interpreting section 21 before starting up the device 36. Therefore, the time-out problem does not occur.

### Eighth Embodiment

Next, an eighth embodiment of the present invention is described in the sixth embodiment of the present invention, the device information which is used for processing the command is determined based on the source of the command.

However, in the eighth embodiment of the present invention, it is determined whether the device information in the cache memory is used based on a source of the command which source does not need to obtain accurate device information. In the eighth embodiment of the present invention, the printing system is the same as that in the fourth embodiment of the present invention.

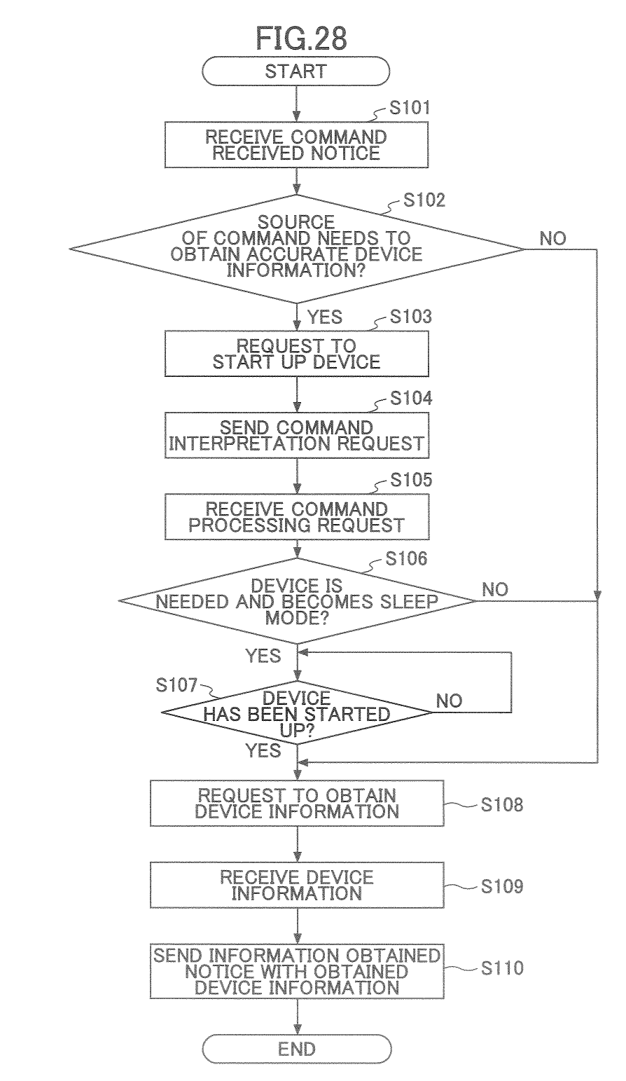

FIG. 28 is a flowchart showing processes in the command processing section 22 when the device information is stored In the cache memory according to the eighth embodiment of the present invention.

In FIG. 28, first, the command processing section 22 receives a command received notice including a command from the data receiving section 32 (S101). The command processing section 22 determines whether the computer 11 is a source which needs to obtain accurate device information for processing the command (S102).

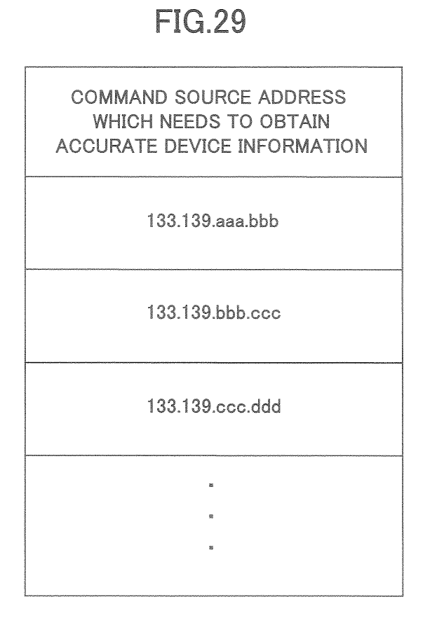

FIG. 29 is a command source address table according to the eighth embodiment of the present invention. The table shown in FIG. 29 is a cache memory utilizing table. In FIG. 29, IP addresses of sources which need to obtain accurate device information are shown. For example, when a command is transmitted from an address “133.139.aaa.bbb”, the command processing section 22 obtains the accurate device information.

The following processes are almost similar to the processes shown in FIG. 20.

When the source of the command is not a source which needs to obtain accurate device information for processing the command (NO in S102), the command processing section 22 sends an information obtaining request to the device controlling section 23 (S108). The command processing section 22 receives the device information from he device controlling section 23 which information is obtained from the cache memory (S109). In addition, the command processing section 22 sends an information obtained notice with the obtained device information to the command interpreting section 21 (S110). As described above, when the device information in the cache memory is used, the time-out problem does not occur even if the device 36 is in the sleep mode.

When the source of the command needs to obtain accurate device information for processing the command (YES in S102), the command processing section 22 requests the device controlling section 23 to start up the device 36 (S103). That is, before determining whether the device 36 iS to be used and whether the device 36 must be started up, the start-up of the device 36 is begun.

Then, the command processing section 22 sends a command interpretation request to the command interpreting section 21 (S104). The command interpreting section 21 interprets a device 36 which is needed for processing the command and interprets whether the device 36 becomes a sleep mode. The command processing section 22 receives a command processing request from the command interpreting section 21 (S105).

The command processing section 22 determines whether the device 36 is needed and whether the device 36 becomes the sleep mode (S106). When the device 36 is not needed (NO in S106), the command processing section 22 sends an information obtaining request to the device controlling section 23 (S108). The device controlling section 23 obtains the device information from the cache memory. The command processing section 22 receives the device information from device controlling section 23 (S109). In addition the command processing section 22 sends an information obtained notice with the obtained device information to the command interpreting section 21 (S110).

When the device 36 is needed and the device 36 becomes the sleep mode (YES in S106), the command processing section 22 determines whether the device 36 (HDD 113) has been started up (S107).

When the device 36 (HDD 113) has not been started up (NO in S107), the command processing section 22 continues to check until the device 36 is started up. When the device 36 is started up (YES in S107), the command processing section 22 sends an information obtaining request to the device controlling section 23 (S108). The command processing section 22 receives the device information from the device controlling section 23 which information is obtained from the device 36 (S109). In addition, the command processing section 22 sends an information obtained notice with the obtained device information to the command interpreting section 21 (S110).

As described above, according to the present embodiment, when the source of the command does not need to obtain the accurate device information since the device information in the cache memory is used, starting up the device 36 is not needed. Therefore, the time-out problem does not occur. In additions when the source of the command needs to obtain the accurate device information, the device information in the device 36 is used. In this cases the command processing section 22 sends the command interpretation request to the command interpreting section 21 before starting up the device 36. Therefore, the time-out problem does not occur.

### Ninth Embodiment

Next, a ninth embodiment of the present invention is described. In the eighth embodiment of the present invention, it is determined whether the device information in the cache memory is used based on the source of the command which source does not need to obtain accurate device in formation.

However in the ninth embodiment of the present invention, it is determined whether the device information in the cache memory is used based on a command which does not need to obtain accurate device information. In the ninth embodiment of the present invention, the printing system is the same as that in the fourth embodiment of the present invention.

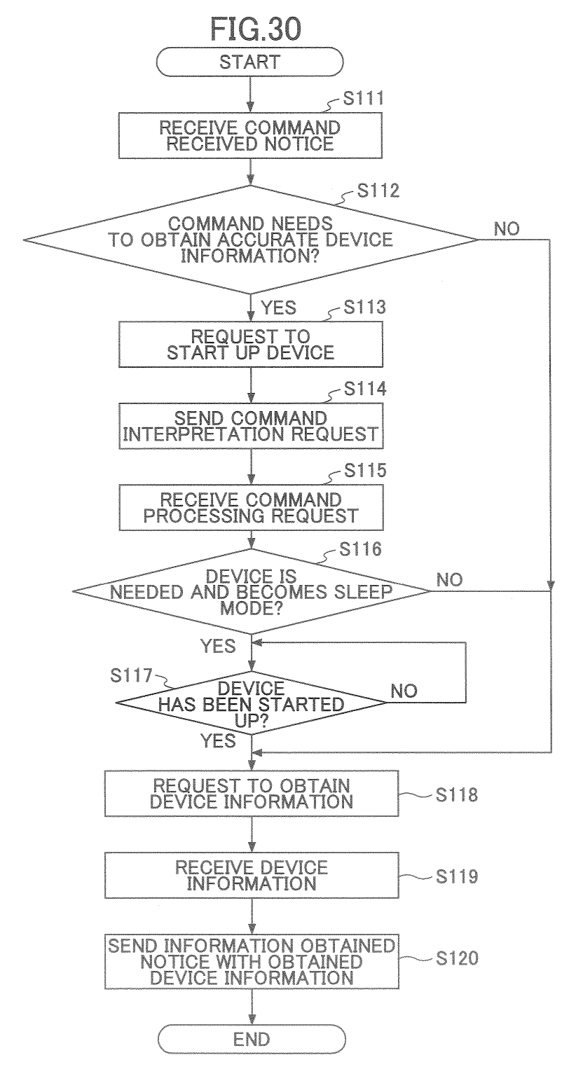

FIG. 30 is a flowchart showing processes in the command processing section 22 when the device information is stored in the cache memory according to the ninth embodiment of the present invention.

In FIG. 30, first, the command processing section 22 receives a command received notice including a command from the data receiving section 32 (S111). The command processing section 22 determines whether the command needs to obtain accurate device information (S112).

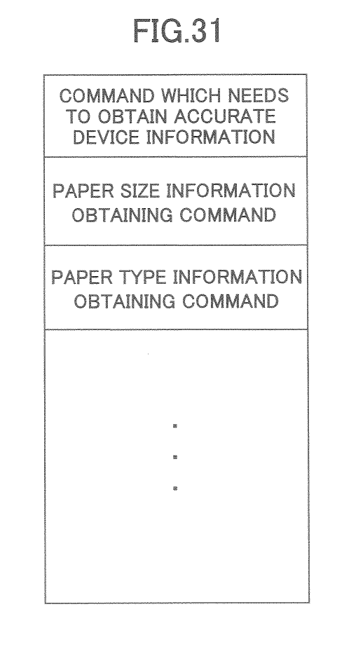

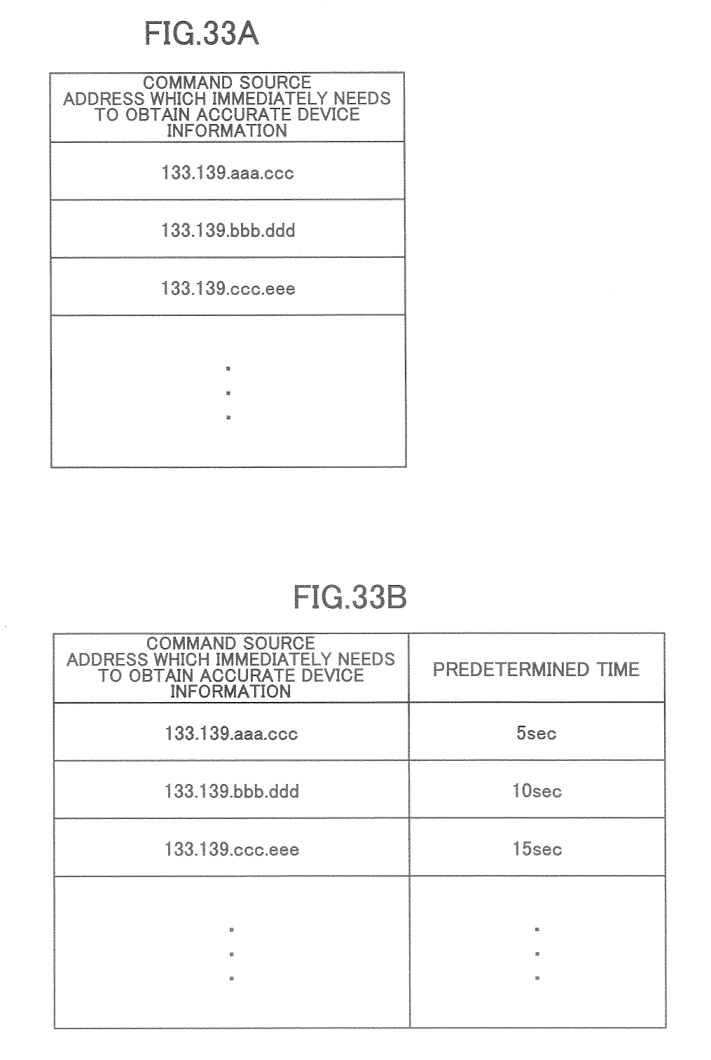

FIG. 31 is a command table according to the ninth embodiment of the present invention. The table shown in FIG. 31 is a cache memory utilizing table. In FIG. 33, commands which need to obtain accurate device information are shown. That is, for example, a paper size information obtaining command and a paper type information obtaining command are shown which commands need to obtain the accurate device information.

The following processes are almost similar to the processes shown in FIG. 20.

When the command does not need to obtain accurate device information (NO in S112), the command processing section 22 sends an information obtaining request to the device controlling section 23 (S118). The command processing section 22 receives the device information from the device controlling section 23 which information is obtained from the cache memory (S119). In additions the command processing section 22 sends an information obtained notice with the obtained device information to the command interpreting section 21 (S120). As described above, when the device information in the cache memory is used, the time-out problem does not occur even if the device 36 is in the sleep mode.

When the command needs to obtain the accurate device information (YES in S112) the command processing section 22 requests the device controlling section 23 to start up the device 36 (S113). That is, before determining whether the device 36 is to be used and whether the device 36 must be started up, the start-up of the device 36 is begun.

Then, the command processing section 22 sends a command interpretation request to the command interpreting section 21 (S114). The command interpreting section 21 interprets a device 36 which is needed for processing the command and interprets whether the device 36 becomes a sleep mode. The command processing section 22 receives a command processing request from the command interpreting section 21 (S115).

The command processing section 22 determines whether the device 36 is needed and whether the device 36 becomes the sleep mode (S116). When the device 36 is not needed (NO in S116), the command processing section 22 sends an information obtaining request to the device controlling section 23 (S118). The device controlling section 23 obtains the device information from the cache memory. The command processing section 22 receives the device information from device controlling section 23 (S119). In addition, the command processing section 22 sends an information obtained notice with the obtained device information to the command interpreting section 21 (S120).

When the device 36 is needed and the device 36 becomes the sleep mode (YES in S116), the command processing section 22 determines whether the device 36 (HDD 113) has been started up (S117).

When the device 36 (HDD 113) has not been started up (NO in S117), the command processing section 22 continues to check until the device 36 is started up. When the device 36 is started up (YES in S117), the command processing section 22 sends an information obtaining request to the device controlling section 23 (S118). The command processing section 22 receives the device information from the device controlling section 23 which information is obtained from the device 36 (S119). In addition, the command processing section 22 sends an information obtained notice with the obtained device information to the command interpreting section 21 (S120).

As described above, according to the present embodiment, when the command does not need to obtain the accurate device information, since the device information in the cache memory is used, starting up the device 36 is not needed. Therefore, the time-out problem does not occur. In addition, when the command needs to obtain the accurate device information, the device information in the device 36 is used. In this case, the command processing section 22 sends the command interpretation request to the command interpreting section 21 before starting up the device 36. Therefore, the time-out problem does not occur.

### Tenth Embodiment

Next, a tenth embodiment of the present invention is described. In the ninth embodiment of the present invention, it is determined whether the device information in the cache memory is to be used based on the command which does not need to obtain accurate device information.

However, in the tenth embodiment of the present invention, it is determined whether the device information in the cache memory is to be used based on a source of the command which source does not immediately need to obtain accurate device information. In the ninth embodiment of the present invention, the printing system is the same as that in the fourth embodiment of the present Invention.

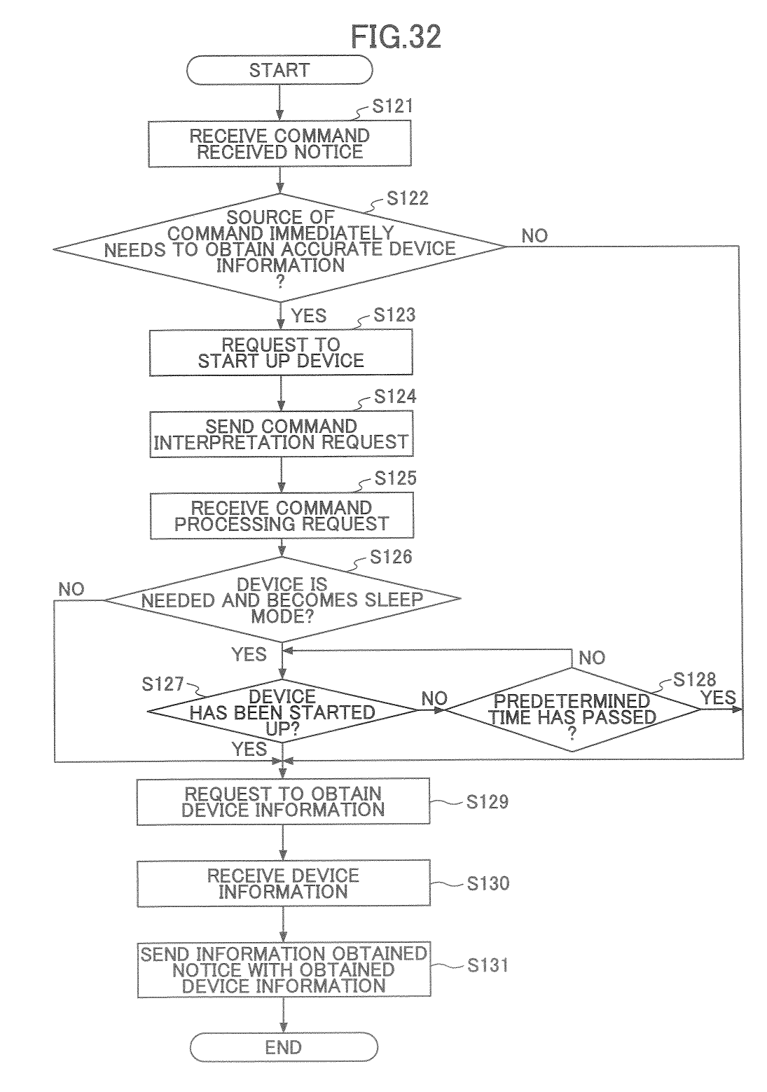

FIG. 32 is a flowchart showing processes in the command processing section 22 when the device information is stored in the cache memory according to the tenth embodiment of the present invention.

In FIG. 32, first, the command processing section 22 receives a command received notice including a command from the data receiving section 32 (S121). The command processing section 22 determines whether the source of the command immediately needs to obtain accurate device information (S122).

FIG. 33A is a command source address table according to the tenth embodiment of the present invention. The table shown in FIG. 33A is a cache memory utilizing table. In FIG. 33A, command source addresses are shown which address immediately needs accurate device information. That is, IP addresses of the sources of the commands are shown which source immediately needs to obtain the accurate device information. For examples when a command is transmitted from an IP address “133.139.aaa.ccc” of a source, in order to immediately transmit accurate device information, device information obtained from the device 36 is transmitted to the source (IP address).

The following processes are almost similar to the processes shown in FIG. 20.

When the source of the command does not immediately need to obtain accurate device information (NO in S122) the command processing section 22 sends an information obtaining request to the device controlling section 23 (S129). The command processing section 22 receives the device information from the device controlling section 23 which information is obtained from the cache memory (S130). In additions the command processing section 22 sends an information obtained notice with the obtained device information to the command interpreting section 21 (S131). As described above, when the device information in the cache memory is used, the time-out problem does not occur even if the device 36 is in the sleep mode.

When the source of the command immediately needs to obtain the accurate device information (YES in S122), the command processing section 22 requests the device controlling section 23 to start up the device 36 (S123) That is, before determining whether the device 36 is to be used and whether the device 36 must be started up, the start-up of the device 36 is begun.

Then, the command processing section 22 sends a command interpretation request to the command interpreting section 21 (S124). The command interpreting section 21 interprets a device 36 which is needed for processing the command and interprets whether the device 36 becomes a sleep mode. The command processing section 22 receives a command processing request from the command interpreting section 21 (S125).

The command processing section 22 determines whether the device 36 is needed and whether the device 36 becomes the sleep mode (S126). When the device 36 is not needed (NO in S126), the command processing section 22 sends an information obtaining request to the device controlling section 23 (S129). The device controlling section 23 obtains the device information from the cache memory. The command processing section 22 receives the device information from device controlling section 23 (S130). In addition, the command processing section 22 sends an information obtained notice with the obtained device information to the command interpreting section 21 (S131).

When the device 36 is needed and the device 36 becomes the sleep mode (YES in S126), the command processing section 22 determines whether the device 36 (HDD 113) has been started up (S127).

When the device 36 (HDD 113) has not been started up (NO in S127), the command processing section 22 determines whether a predetermined time has passed after receiving the command (S128). The command interpreting section 21 does not have the time-out problem within the predetermined time. In addition, the predetermined time satisfies that the source of the command immediately obtain the accurate device information. When the predetermined time has not passed after receiving the command (NO in S128), determination whether the device 36 (HDD 113) has been started up is repeated (S127).

When the predetermined time has passed after receiving the command (YES in S128), the command processing section 22 sends an information obtaining request to the device controlling section 23 (S129). The command processing section 22 receives the device information from the device controlling section 23 which information is obtained from the cache memory (S130). In addition, the command processing section 22 sends an information obtained notice with the obtained device information to the command interpreting section 21 (S131).

When the device 36 (HDD 113) has been started up (YES in S127), the command processing section 22 sends a, information obtaining request to the device controlling section 23 (S129). The command processing section 22 receives the device information from the device controlling section 23 which information is obtained from the device 36 (S130). In addition, the command processing section 22 sends an information obtained notice with the obtained device information to the command interpreting section 21 (S131).

As described above, according to the present embodiment, when the source of the command needs to immediately obtain the accurate device information, it is attempted that the device information be obtained from the device 36. However, when the device 36 does not start up within the predetermined time, the device information is obtained from the cache memory. Therefore, the time-out problem does not occur.

In the tenth embodiment of the present invention, waiting time until the device 36 is started up, that is, the predetermined time is defined as one interval. However, the predetermined time can be different among the sources FIG. 33B is a predetermined time table according to the tenth embodiment of the present invention. The table shown in FIG. 33B is a cache memory utilizing table. As shown in FIG. 33, the predetermined time is different among the sources. When the predetermined time table shown in FIG. 33B is used, the waiting time until the device 36 is started up can be changed corresponding to the sources.

The predetermined time table shown in FIG. 33B can be stored in the NV-RAM 117 beforehand, or can be set by a user. The user can set the predetermined time from the operating panel 101 of the image forming apparatus 12 or the computer 11 by using Web application software.

When the user sets the predetermined time, in order to avoid the time-out problem, it is preferable that the command processing section 22 send a command interpretation request to the command interpreting section 21 before the process in S123, that is, before the command processing section 22 requests the device controlling section 23 to start up he device 36.

### Eleventh Embodiment

Next, an eleventh embodiment of the present invention is described in the tenth embodiment of the present invention, it is determined whether the device information in the cache memory is used based on the source of the command which source does not immediately need to obtain accurate device information.

However, in the eleventh embodiment of the present invention, it is determined whether the device information in the cache memory is used based on a command which does not immediately need to obtain accurate device information. In the eleventh embodiment of the present invention, the printing system is the same as that in the fourth embodiment of the present invention.

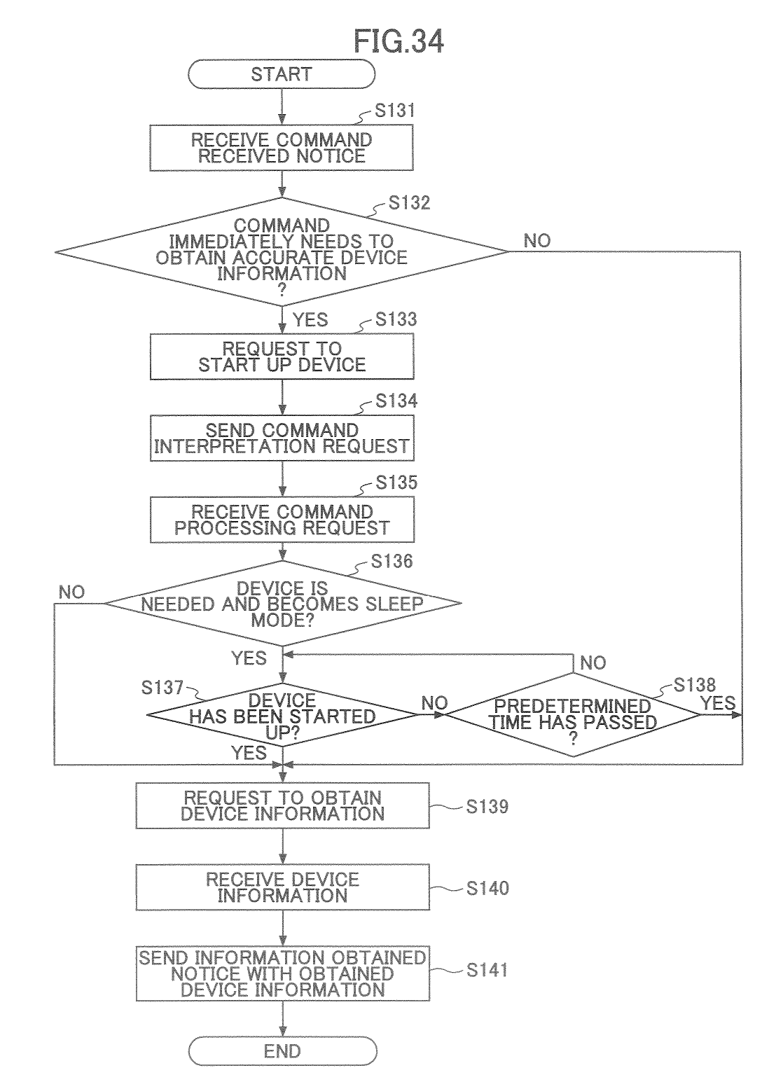

FIG. 34 is a flowchart showing processes in the command processing section 22 when the device information is stored in the cache memory according to the eleventh embodiment of the present invention.

In FIG. 34, first, the command processing section 22 receives a command received notice including a command from the data receiving section 32 (5131). The command processing section 22 determines whether the command immediately needs to obtain accurate device information (S132).

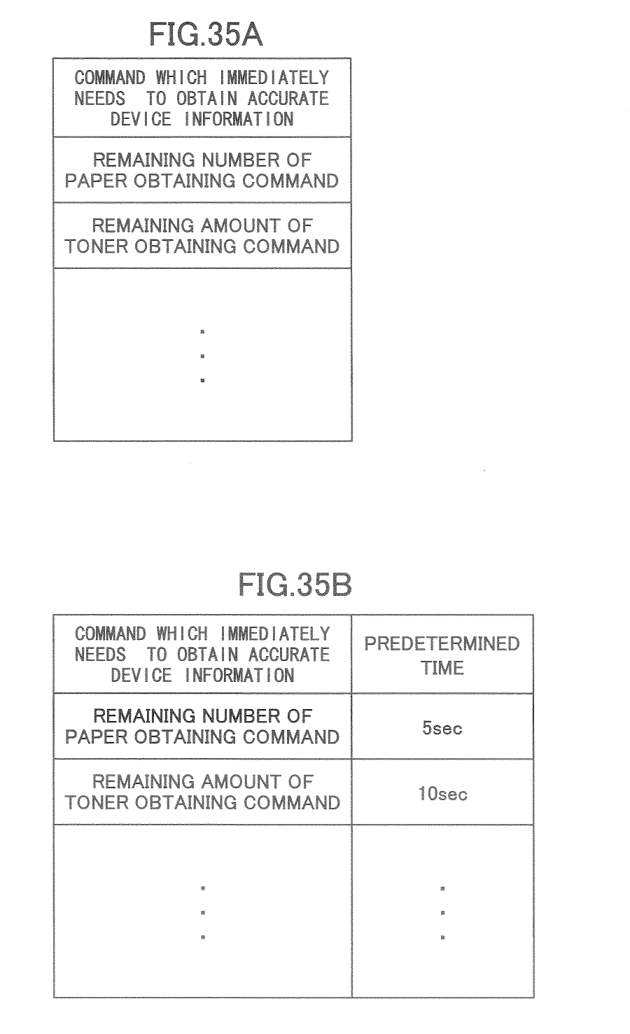

FIG. 35A is a command table according to the eleventh embodiment of the present invention. The table shown in FIG. 35A is a cache memory utilizing table in FIG. 35A, commands are shown which command immediately needs to obtain accurate device information. That is in FIG. 35A, for examples a remaining number of paper obtaining command and a remaining amount of toner obtaining command are shown. Therefore, when the remaining number of paper obtaining command is transmitted, in order to immediately transmit accurate device information, the device information is obtained from the device 36 within a predetermined time, and the obtained device information is transmitted to the source of the command.

The following processes are almost similar to the processes shown in FIG. 32.

When the command does not immediately need to obtain accurate device information (NO in S132), the command processing section 22 sends an information obtaining request to the device controlling section 23 (S139). The command processing section 22 receives the device information from the device controlling section 23 which information is obtained from the cache memory (S140). In addition, the command processing section 22 sends an information obtained notice with the obtained device information to the command interpreting section 21 (S141). As described above, when the device information in the cache memory is used, the time-out problem does not occur even if the device 36 is in the sleep mode.

When the command immediately needs to obtain the accurate device information (YES in S132), the command processing section 22 requests the device controlling section 23 to start up the device 36 (S133). That is, before determining whether the device 36 is to be used and whether the device 36 must be started up, the start-up of the device 36 is begun.

Then, the command processing section 22 sends a command interpretation request to the command interpreting section 21 (S134). The command interpreting section 21 interprets a device 36 which is needed for processing the command and Interprets whether the device 36 becomes a sleep mode. The core and processing section 22 receives a command processing request from the command interpreting section 21 (S135).

The command processing section 22 determines whether the device 36 is needed and whether the device 36 becomes the sleep mode (S136). When the device 36 is not needed (NO in S136), the command processing section 22 sends an information obtaining request to the device controlling section 23 (S139). The device controlling section 23 obtains the device information from the cache memory. The command processing section 22 receives the device information from device controlling section 23 (S140). In addition, the command processing section 22 sends an information obtained notice with the obtained device information to the command interpreting section 21 (S141).

When the device 36 is needed and the device 36 becomes the sleep mode (YES in S136), the command processing section 22 determines whether the device 36 (HDD 113) has been started up (S137).

When the device 36 (HDD 113) has not been started up (NO in S137), the command processing section 22 determines whether a predetermined time has passed after receiving the command (S138). Within the predetermined time, the command interpreting section 21 does not have the time-out problem. In addition, the predetermined time satisfies that the command immediately obtains the accurate device information. When the predetermined time has not passed after receiving the command (NO in S138), determination whether the device 36 (HDD 113) has been started up is repeated (S137).

When the predetermined time has passed after receiving the command (YES in S138) the command processing section 22 sends an information obtaining request to the device controlling section 23 (S139). The command processing section 22 receives the device information from the device controlling section 23 which information is obtained from the cache memory (S14O). In addition, the command processing section 22 sends an information obtained notice with the obtained device information to the command interpreting section 21 (S141).

When the device 36 (HDD 113) has been started up (YES in S137), the command processing section 22 sends an information obtaining request to the device controlling section 23 (S139). The command processing section 22 receives the device information from the device controlling section 23 which information is obtained from the device 36 (S14O). In addition, the command processing section 22 sends an information obtained notice with the obtained device information to the command interpreting section 21 (S141).

As described above, according to the present embodiment, in a case where the command immediately needs to obtain the accurate device information, when the predetermined time has passed, the device information is obtained from the cache memory without waiting for the start-up of the device 36. With this, the time-out problem is prevented while satisfying the need to immediately obtain the device information.

In addition, according to the present embodiment, it is attempted that the device information be obtained from the device 36. However, when the device 36 does not start up within the predetermined time, the device information is obtained from the cache memory. Therefore, the time-out problem does not occur.

In the eleventh embodiment of the present invention, waiting time until the device 36 is started up, that is, the predetermined time is defined as one. However, the predetermined time can be different among the commands. FIG. 35B is a predetermined time table according to the eleventh embodiment of the present invention. The table shown in FIG. 35B is a cache memory utilizing table. As shown in FIG. 35B, the predetermined time is different among the commands. When the predetermined time table shown in FIG. 35B is used, the waiting time until the device 36 is started up can be changed corresponding to the commands.

The predetermined time table shown in FIG. 35B can be stored in the NV-RAM 117 beforehand, or can be set by a user. The user can set the predetermined time from the operating panel 101 of the image forming apparatus 12 or the computer 11 by using Web application software.

When the user sets the predetermined time, in order to avoid the time-out problem, it is preferable that the command processing section 22 send a command interpretation request to the command interpreting section 21 before the process in S133, that is, before the command processing section 22 requests the device controlling section 23 to start up the device 36.

As described above, according to the image forming apparatus in the embodiments of the present invention, even if a device, from which device information is obtained, is not started up, the time-out problem does not occur.

Further, the present invention is not limited to the specifically disclosed embodiments, and variations and modifications may be made without departing from the scope of the present invention.

The present invention is based on Japanese Priority Patent Application No. 2006-023045, filed on Jan. 31, 2006, with the Japanese Patent Office, the entire contents of which are hereby incorporated herein by reference.

What is claimed is:

1. An image forming apparatus comprising:
a data receiving section connected to a computer via a network for receiving a command from the computer;
a command processing section for processing the command received by the data receiving section;
a command interpreting section for interpreting the command; and
a data transmitting section for transmitting device information obtained by the command processing section; wherein
the command processing section requests the command interpreting section to interpret the command before completing a start-up of a device from which the command processing section obtains the device information.

2. The image forming apparatus as claimed in claim 1, further comprising:
a device controlling section for controlling the device; wherein
the command processing section requests the device controlling section to start up the device before receiving an interpreted result of the command from the command interpreting section.

3. The image forming apparatus as claimed in claim 2, wherein:
the command interpreting section includes a device table in which a relationship between the command and the device is described;
the command interpreting section identifies the device related to the command by referring to the device table; and
the command processing section requests the device controlling section to start up the device identified by the command interpreting section.

4. The image forming apparatus as claimed in claim 2, further comprising:
a device information caching unit for caching the device information of the device in a cache memory; wherein
the device controlling section caches the device information in the cache memory at a predetermined interval or before the device enters a sleep mode by using the device information caching unit.

5. The image forming apparatus as claimed in claim 4, further comprising:
a cache memory utilizing table in which an address or a command that needs to obtain the device information from the cache memory is registered; wherein
the command processing section determines whether the device information is obtained from the cache memory by referring to the cache memory utilizing table or from the device.

6. The image forming apparatus as claimed in claim 5, wherein:
the address in the cache memory utilizing table is a command source address which immediately needs to obtain the device information and the command in the cache memory utilizing table is a command which immediately needs to obtain the device information.

7. The image forming apparatus as claimed in claim 5, wherein:
the address in the cache memory utilizing table is a command source address which immediately needs to obtain accurate device information; and
when the command processing section cannot obtain the device information from the device for a predetermined time,
the command processing section obtains the device information from the cache memory.

8. The image forming apparatus as claimed in claim 5, wherein:
the command in the cache memory utilizing table is a command which immediately needs to obtain accurate device information; and
when the command processing section cannot obtain the device information from the device for a predetermined time
the command processing section obtains the device information from the cache memory.

9. The image forming apparatus as claimed in claim 7, wherein:
the predetermined time can be set by a user.

10. An image forming apparatus, comprising:
a data receiving section connected to a computer via a network for receiving a command from the computer;
a command processing section for processing the command received by the data receiving section;
a command interpreting section for interpreting the command; and
a data transmitting section for transmitting device information obtained by the command processing section; wherein
when a device is connected to the image forming apparatus via the network from which device the command processing section obtains the device information,
the command processing section requests the command interpreting section to interpret the command before accessing the device via the network.

11. The image forming apparatus as claimed in claim 10, further comprising:
a device controlling section for controlling the device; wherein
the command processing section requests the device controlling section to start up the device before receiving an interpreted result of the command from the command interpreting section.

12. The image forming apparatus as claimed in claim 11 wherein:
when a plurality of the devices are connected to the image forming apparatus via the network,
the command processing section requests the device controlling section to access a first device; and
when the device controlling section cannot access the first device for a predetermined time,
the command processing section requests the device controlling section to access a second device.

13. The image forming apparatus as claimed in claim 11, further comprising:
a device information caching unit for caching the device information of the device in a cache memory; wherein
the device controlling section caches the device information in the cache memory at a predetermined interval or before the device enters a sleep mode by using the device information caching unit.

14. The image forming apparatus as claimed in claim 13, further comprising:
a cache memory utilizing table in which an address or a command that needs to obtain the device information from the cache memory is registered; wherein
the command processing section determines whether the device information is obtained from the cache memory by referring to the cache memory utilizing table or from the device.

15. The image forming apparatus as claimed in claim 14, wherein:
the address in the cache memory utilizing table is a command source address which immediately needs to obtain the device information and the command in the cache memory utilizing table is a command which immediately needs to obtain the device information.

16. The image forming apparatus as claimed in claim 14, wherein:
the address in the cache memory utilizing table is a command source address which immediately needs to obtain accurate device information; and
when the command processing section cannot obtain the device information from the device for a predetermined time,
the command processing section obtains the device information from the cache memory.

17. The image forming apparatus as claimed in claim 14, wherein:
the command in the cache memory utilizing table is a command which immediately needs to obtain accurate device information; and
when the command processing section cannot obtain the device information from the device for a predetermined time,
the command processing section obtains the device information from the cache memory.

18. The image forming apparatus as claimed in claim 16, wherein:
the predetermined time can be set by a user.

19. A data processing method in an image forming apparatus, comprising the steps of:
receiving a command from a computer connected via a network;
requesting to start up a device from which device information is obtained based on the command;
interpreting the command before completing the start-up of the device;
processing the command based on an interpreted result;
obtaining the device information from the device; and
transmitting the obtained device information to the computer.

20. A computer-readable recording medium storing a program of a method, comprising:
method as claimed in claim 19.
